(19) United States
(12) Patent Application Publication
(10) Pub. No.: US 2020/0216624 A1
(43) Pub. Date: Jul. 9, 2020

(54) CELLULOSE COMPOSITE MATERIALS

(71) Applicant: INTERNATIONAL PAPER COMPANY, Memphis, TN (US)

(72) Inventors: Robert T. Hamilton, Seattle, WA (US); Harshadkumar M. Shah, Bonney Lake, WA (US); Jorge Cortes, Memphis, TN (US); Hugh West, Seattle, WA (US); Rob Banning, St. Louis, MO (US)

(73) Assignee: INTERNATIONAL PAPER COMPANY, Memphis, TN (US)

(21) Appl. No.: 16/818,171

(22) Filed: Mar. 13, 2020

Related U.S. Application Data
(63) Continuation of application No. PCT/US2018/051346, filed on Sep. 17, 2018.
(60) Provisional application No. 62/562,309, filed on Sep. 22, 2017.
(60) Provisional application No. 62/559,467, filed on Sep. 15, 2017.

(51) Int. Cl. C08J 5/04; C08K 7/14; B29C 45/00

(52) U.S. Cl. CPC C08J 5/045; C08K 7/14; B29K 2509/08; B29C 45/0013; B29C 45/0005

(57) ABSTRACT

A composite material includes a thermoplastic polymer matrix throughout which cellulose pulp fibers and filler material are dispersed. The composite may be in solid (e.g. pellet) form, or molten form. The presence of cellulose pulp fibers unexpectedly reduces cycle time, and/or unexpectedly improves certain properties, when the composite is used in injection molding. A method for molding a part includes providing a solid composite that includes thermoplastic polymer, filler material, and cellulose pulp fibers to an injection molding system; melting the polymer to produce a molten mixture; and injecting the molten mixture into a mold. Another method for molding a part includes injecting a molten mixture of thermoplastic polymer, filler material, and cellulose pulp fibers into a mold; and removing the formed part from the mold after a cycle time at least 10% less than that required when using a comparable molten mixture that excludes the pulp fibers.

### CROSS-REFERENCES TO RELATED APPLICATIONS

This application is a continuation of International Patent Application No. PCT/US2018/051346, filed Sep. 17, 2018, which claims the benefit of U.S. Provisional Application No. 62/562,309, filed Sep. 22, 2017, and the benefit of U.S. Provisional Application No. 62/559,467, filed Sep. 15, 2017, the disclosures of all of which are expressly incorporated by reference herein in their entirety.

### BACKGROUND

Various materials have been added to polymers in order to provide reinforcement, impart desirable physical characteristics, reduce the amount of polymer needed for a given application, and so forth. A traditional material for reinforcement is glass fibers, which may impart high strength, dimensional stability, and heat resistance to a polymer composite. However, glass fibers are costly, abrade processing equipment and increase the density of the plastic systems. In certain applications, these disadvantages outweigh the advantages of using glass fibers as a reinforcement additive.

Cellulosic pulp materials have been evaluated as fillers for plastics in the past, and composite materials in which cellulose wood pulp fibers are used to provide reinforcement for thermoplastic polymers are disclosed, for example, in U.S. Pat. Nos. 6,270,883, 9,328,231, and 9,617,687.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a composite material is provided, which includes a thermoplastic polymer, cellulose pulp fibers, and a filler material, in which the thermoplastic polymer is a matrix throughout which the cellulose pulp fibers and filler material are dispersed.

The thermoplastic polymer may include one or more polymers selected from the group consisting of polypropylene, polyethylene, polylactic acid, polystyrene, polystyrene copolymers, polyoxymethylene, cellulose acetate, cellulose proprionate, cellulose butyrate, polycarbonates, polyethylene terephthalate, polyesters other than polyethylene terephthalate, polyacrylates, polymethacrylates, fluoropolymers, polyamides, polyetherimide, polyphenylene sulfide, polysulfones, poly(p-phenylene oxide), polyurethanes, and thermoplastic elastomers.

The filler material may include one or more materials selected from the group consisting of glass fibers, minerals, polymers having a melting point higher than that of said thermoplastic polymer, and lignocellulosic materials.

The cellulose pulp fibers may include cellulose wood pulp fibers, such as cellulose wood pulp fibers selected from the group consisting of chemical wood pulp fibers, bleached wood pulp fibers, bleached chemical wood pulp fibers, Northern bleached softwood kraft (NBSK) pulp fibers, Southern bleached softwood kraft (SBSK) pulp fibers, and dissolving wood pulp fibers, eucalyptus pulp fibers, and hardwood pulp fibers other than eucalyptus pulp fibers.

The composite material may further include one or more additives selected from the group consisting of compatibilizers, lubricants, coupling agents, impact modifiers and acid scavengers.

In certain illustrative embodiments, the composite material may include at least 60 weight % of the thermoplastic polymer and at least 2 weight % cellulose pulp fibers.

In certain illustrative embodiments, the filler material includes glass fibers, and the composite material includes at least 5 weight % glass fibers.

In certain illustrative embodiments, the composite material comprises no more than 20 weight % additives.

For example, in some illustrative, non-limiting example embodiments of a composite material in accordance with the present disclosure, the thermoplastic material includes polypropylene, the filler material includes glass fibers, and the cellulose pulp fibers include cellulose wood pulp fibers. The composite material in these example embodiments includes at least 60 weight % polypropylene, at least 10 weight % glass fibers, at least 5 weight % cellulose pulp fibers, and no more than 10 weight % additives. In some of these example embodiments, the additives are selected from the group consisting of compatibilizers, lubricants, coupling agents, impact modifiers and acid scavengers. In some of these example embodiments, the additives are selected from the group consisting of compatibilizers, lubricants, coupling agents and acid scavengers.

In a related aspect, the composite material may be in solid form, such as in the form of a pellet suitable for use in injection molding, or another solid form suitable for use in other production methods. In another related aspect, the composite material may be in molten form, such as when at least some of the thermoplastic polymer is heated to above its melting point, even though the filler material and the cellulose pulp fibers remain in solid form, dispersed throughout the thermoplastic polymer matrix. In molten form, the composite material may be flowable, and as such may be used for injection molding a part.

In a related aspect, an injection molded part produced from a composite material as disclosed herein may exhibit a cycle time reduction of at least 10% compared to the cycle time required for producing the part using a comparable molten mixture that includes the thermoplastic polymer but that excludes the cellulose pulp fibers. In another related aspect, an injection molded part produced from a composite material as disclosed herein may exhibit less shrinkage upon cooling as compared to the same part produced from a comparable molten mixture that includes the thermoplastic polymer but that excludes the cellulose pulp fibers. In another related aspect, an injection molded part produced from a composite material as disclosed herein may be less anisotropic in one or more mechanical properties, and/or less asymmetrical in shrinkage upon cooling, compared to the same part produced from a comparable composite material that includes the thermoplastic polymer but that excludes the cellulose pulp fibers.

In another aspect, methods for molding a part using a composite material are provided, in which the composite material includes a thermoplastic polymer, cellulose pulp fibers, and a filler material, and in which the thermoplastic polymer is a matrix throughout which the cellulose pulp fibers and filler material are dispersed.

In a related aspect, a method for molding a part may include providing a solid composite that includes thermoplastic polymer, filler material, and cellulose pulp fibers to an injection molding system; melting at least some of the thermoplastic polymer in the injection molding system to produce a molten mixture; and injecting the molten mixture into a mold to form a part.

In another related aspect, a method for molding a part may include dry blending a first composite of thermoplastic polymer and glass fibers with a second composite of thermoplastic polymer and cellulose fibers to produce a mixture comprising at least 60 weight % thermoplastic polymer and at least 2 weight % cellulose fibers; melting at least some of the thermoplastic polymer in the mixture to produce a molten mixture in which the glass fibers and cellulose pulp fibers are dispersed; and injecting the molten mixture into a mold to form a part.

In another related aspect, a method for molding a part may include injecting a molten mixture of thermoplastic polymer, filler material, and cellulose pulp fibers into a mold, wherein the thermoplastic polymer forms a matrix throughout which the filler material and cellulose pulp fibers are dispersed, to form a part. After injecting, some methods may then include removing the formed part from the mold after a cycle time that is at least 10% less than the cycle time required for forming the part using a comparable molten mixture that includes the thermoplastic polymer but that excludes the cellulose pulp fibers. In some methods, the injecting may be done at a lower injection molding temperature than the injection molding temperature required for forming the part using a comparable molten mixture that includes the thermoplastic polymer but that excludes the cellulose pulp fibers. In some methods, the injecting may include using a mold having one or more dimensional characteristics that are closer to the desired final dimensional characteristics of the molded part as compared to a mold for use with the comparable molten mixture.

Such methods may include, prior to injecting a molten mixture, providing the molten mixture by combining the components of the mixture, and then melt-mixing the combined components. For example, such a method may include combining thermoplastic polymer in solid form, filler material, and cellulose pulp fibers, followed by melt-mixing. In some embodiments, combining includes dry blending two or more of the components of the composite, and then performing melt-mixing in an injection molding system. In some embodiments, melt-mixing is performed prior to introducing the molten mixture to the injection molding system, such as a method that includes placing a solid composite that includes all of the components of the composite material (e.g., thermoplastic polymer, filler material, cellulose pulp fibers, and optionally additives) into an injection molding system, and then melting at least some of the thermoplastic polymer in the injection molding system.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a drawing showing a first dimensional view of an example injection molded part produced using composite materials in accordance with the present disclosure, in the form of a step stool.

FIG. 2 is a drawing showing a second dimensional view of the injection molded part shown in FIG. 1.

FIG. 3 is a graph showing predicted and actual injection molding cycle times for producing injection molded part shown in FIGS. 1 and 2, as cellulose pulp fiber content increases in polypropylene composite materials.

FIG. 4 is a graph showing the actual cycle time data from FIG. 3, as a line.

FIG. 5 is a graph similar to FIG. 3, but showing predicted and actual cycle times as cellulose pulp fiber content increases in polypropylene composite materials that include glass fibers.

FIG. 6 is a graph showing the actual cycle time data from FIG. 5, as a line.

FIG. 7 is a graph similar to FIG. 3, but showing predicted and actual cycle times as cellulose pulp fiber content increases in various polypropylene composite materials.

FIG. 8 is a graph showing actual cycle time data as cellulose pulp fiber content increases in various composite materials that include talc and/or copolymer polypropylene.

FIG. 9 is a graph showing actual cycle times as cellulose pulp fiber content increases in various polymer composite materials.

FIG. 10 is a graph showing predicted and actual values for tensile strength of polypropylene composite materials as cellulose pulp fiber content increases.

FIG. 11 is a graph showing predicted and actual values for flexural modulus of polypropylene composite materials as cellulose pulp fiber content increases.

FIG. 12 is a graph showing predicted and actual values for tensile modulus of polypropylene composite materials as cellulose pulp fiber content increases.

FIG. 13 is a graph showing predicted and actual values for Izod impact strength of polypropylene composite materials as cellulose pulp fiber content increases.

FIG. 14 is a graph showing predicted and actual values for tensile elongation at break of polypropylene composite materials as cellulose pulp fiber content increases.

FIG. 15 is a graph showing predicted and actual values for tensile strength and flexural strength of polypropylene composite materials that include glass fibers, as cellulose pulp fiber content increases.

FIG. 16 is a graph showing predicted and actual values for tensile modulus and flexural modulus of polypropylene composite materials that include glass fibers, as cellulose pulp fiber content increases.

FIG. 17 is a graph showing predicted and actual values for Izod impact strength of polypropylene composite materials that include glass fibers, as cellulose pulp fiber content increases.

FIG. 18 is a graph showing predicted and actual values for tensile elongation at break of polypropylene composite materials that include glass fibers, as cellulose pulp fiber content increases.

### DETAILED DESCRIPTION

The present disclosure is directed to composite materials, specifically thermoplastic composite materials that include a filler material as well as cellulose pulp fibers. Methods for the production of such composite materials, and various methods of using such composite materials, such as in injection molding, are also disclosed.

In such composite materials, the filler material and cellulose pulp fibers are dispersed throughout the thermoplastic polymer, which forms a surrounding matrix. Put another way, such composite materials include a thermoplastic polymer having cellulose pulp fibers and filler material dispersed throughout.

As explained in greater detail below, the aforementioned, respective components of the composite materials discussed herein may consist of a single material, or may be combinations of different materials. That is, for example, the term “thermoplastic polymer” may refer to a thermoplastic polymer component consisting of one or more different thermoplastic polymers (e.g., polypropylene, polyethylene, and so forth). Similarly, the term “filler material” may refer to a filler material component consisting of one or more different filler materials (e.g., glass fibers, minerals, and so forth), and “cellulose pulp fibers” may refer to a cellulose pulp fiber component consisting of one or more different cellulose pulp fiber materials (e.g., cellulose wood pulp fibers, Southern bleached kraft pulp fibers, and so forth).

In some composite materials, the presence of cellulose pulp fibers provides a composite material that achieves significant and unexpected cycle time reduction when used in injection molding, as compared to a comparable composite material that includes the thermoplastic polymer but that excludes the cellulose pulp fibers. In such embodiments, a significant percentage of the reduction in cycle time has been observed with only a small amount of cellulose pulp fibers in the blend.

In some of such embodiments, the presence of cellulose pulp fibers provides a composite material that may be injection molded at a lower temperature as compared to a comparable composite material that includes the thermoplastic polymer but that excludes the cellulose pulp fibers.

In some of such embodiments, such as those in which the filler material includes glass fibers or other fibers with a generally circular cross-section, the presence of cellulose fibers provides a composite material that can be used to produce an injection molded part that will exhibit less anisotropy in various mechanical properties, as compared to an injection molded part produced using a comparable composite material that includes the thermoplastic polymer but that excludes the cellulose pulp fibers.

In many cases, cellulose pulp fibers are lighter in weight as compared to traditional filler materials such as glass fibers. Cellulose pulp fibers also tend to be less abrasive as compared to traditional filler materials such as glass fibers, and thus can subject handling and processing machinery to comparatively less wear. Cellulose pulp fibers are also a renewable and recyclable resource and can achieve lower carbon emissions during production and use as compared to many traditional filler materials. As such, the use of cellulose pulp fibers in thermoplastic composite materials as an alternative to, or partial replacement of, traditional filler materials such as glass fibers, can achieve savings related to comparatively lower weight of materials, less wear of machinery, less environmental impact, and so forth.

In one aspect, the present disclosure is directed to a composite material that includes a thermoplastic polymer, cellulose pulp fibers, and a filler material, in which the thermoplastic polymer is a matrix throughout which the cellulose pulp fibers and filler material are dispersed.

In a related aspect, the composite material may be in solid form, such as in the form of a pellet suitable for use in injection molding, or another solid form suitable for use in other production methods. In another related aspect, the composite material may be in molten form, such as when at least some of the thermoplastic polymer is heated to above its melting point, even though the filler material and the cellulose pulp fibers remain in solid form, dispersed throughout the thermoplastic polymer matrix. In molten form, the composite material may be flowable, and as such may be used for injection molding a part.

As explained further herein, the composite materials in accordance with the present disclosure may include one or more additives, such as various compatibilizers, lubricants, coupling agents, impact modifiers, acid scavengers, and so forth. The term “additives,” as a component of the aforementioned composite materials, refers to an additive component consisting of one or more of such additives.

In one illustrative, non-limiting example embodiment of a composite material in accordance with the present disclosure, the thermoplastic material includes polypropylene, the filler material includes glass fibers, and the cellulose pulp fibers include cellulose wood pulp fibers. The composite material in this example embodiment includes at least 60 weight % polypropylene, at least 10 weight % glass fibers, at least 5 weight % cellulose pulp fibers, and no more than 10 weight % additives.

In another illustrative, non-limiting example embodiment of a composite material in accordance with the present disclosure, the thermoplastic material includes polypropylene, the filler material includes talc, and the cellulose pulp fibers include cellulose wood pulp fibers. This example embodiment includes at least 60 weight % polypropylene, at least 5 weight % talc, at least 5 weight % cellulose pulp fibers, and no more than 10 weight % additives.

In another aspect, the present disclosure is directed to methods for molding a part using a composite material that includes a thermoplastic polymer, cellulose pulp fibers, and a filler material, in which the thermoplastic polymer is a matrix throughout which the cellulose pulp fibers and filler material are dispersed.

In a related aspect, a method may include injecting a molten mixture of thermoplastic polymer, filler material, and cellulose pulp fibers into a mold, wherein the thermoplastic polymer forms a matrix throughout which the filler material and cellulose pulp fibers are dispersed, to form a part. A method may then include removing the formed part from the mold after a cycle time that is at least 10% less than the cycle time required for forming the part using a comparable molten mixture that includes the thermoplastic polymer but that excludes the cellulose pulp fibers.

In another related aspect, a method may include, prior to injecting a molten mixture, providing the molten mixture by combining the components of the mixture, and then melt-mixing the combined components. For example, such a method may include combining thermoplastic polymer in solid form, filler material, and cellulose pulp fibers, followed by melt-mixing. As explained in more detail below, “combining” in this sense encompasses all manner of producing a mixture from the aforementioned components. In some embodiments of such a method, combining includes dry blending two composite materials, such as a first composite that includes thermoplastic polymer and filler material, and a second composite that includes thermoplastic polymer and cellulose pulp fibers. The compositional makeup of the thermoplastic polymer in the two composites may be the same, may include one or more thermoplastic polymers in common (such as, for example, polypropylene), or may be entirely different. The composites may be in pellet or other solid particulate form, such that the dry blending may be performed by placing measured amounts of each type of composite into the hopper of an injection molding machine or system, or into a barrel or other container to pre-mix the pellets prior to placing the mixture into the hopper of an injection molding machine or system. In some embodiments, filler material may be dry blended with a composite that includes thermoplastic polymer and cellulose pulp fibers. In some embodiments, cellulose pulp fibers may be dry blended with a composite that includes thermoplastic polymer and filler material. In some embodiments, the components may be provided in individual or “neat” form and then mixed. Optionally, combining may include comminuting or otherwise breaking up one or more of the components into particulate form prior to, or as part of, the mixing process. In some of such methods, melt-mixing may be performed in the injection molding system, such as by heating the combined components in the barrel of the injection molding system to melt at least some of the thermoplastic polymer to provide a molten mixture. In some of such methods, melt-mixing may be performed prior to introducing the molten mixture to the injection molding system.

In yet another related aspect, a method may include, prior to injecting a molten mixture, providing the molten mixture by placing a solid composite that includes all of the components of the composite material (e.g., thermoplastic polymer, filler material, cellulose pulp fibers, and optionally additives) into an injection molding system, and then melting at least some of the thermoplastic polymer in the injection molding system. In other words, in such methods, the composite material is pre-blended (and, for example, shaped into pellets) upon introducing it to the injection molding system. Thus, some of such methods may further include producing the solid composite, i.e. upstream of its introduction into the injection molding system. Production may be accomplished by all manner of methods, such as by melt-processing the components separately or as composites using suitable equipment, such as a single-screw extruder, a twin-screw extruder, a high-intensity mixer, or other types of mixing equipment, or combinations thereof.

As described more fully below, methods for molding a part using a composite material in accordance with the present disclosure may include removing the formed part from the mold after a cycle time that is less than the cycle time required for forming the part using a comparable molten mixture that includes the thermoplastic polymer but that excludes the cellulose pulp fibers. The reduction in cycle time is significant even when low levels of cellulose are used. Moreover, although the cycle time reduction may correlate somewhat to the relative amounts of cellulose pulp fibers and filler materials in a composite material, it has surprisingly been found that cycle time does not follow the expected behavior that would be predicted by the general Rule of Mixtures. Thus, some of such methods include removing the formed part from the mold after a cycle time that is at least 10% less than the cycle time required for forming the part using a comparable molten mixture that includes the thermoplastic polymer but that excludes the cellulose pulp fibers. Some of such methods include removing the formed part from the mold after a cycle time that is at least 20%, 30%, 40%, 45%, and 50% less than the cycle time required for forming the part using a comparable molten mixture that includes the thermoplastic polymer but that excludes the cellulose pulp fibers.

In another related aspect, a method may include injecting at a lower injection molding temperature than the injection molding temperature required for forming the part using a comparable molten mixture that includes the thermoplastic polymer but that excludes the cellulose pulp fibers.

In one illustrative, non-limiting example embodiment of a method for molding a part in accordance with the present disclosure, the method includes dry blending a first composite of thermoplastic polymer and glass fibers with a second composite of thermoplastic polymer and cellulose fibers to produce a mixture comprising at least 60 weight % thermoplastic polymer and at least 2 weight % cellulose fibers. The method in this example embodiment then includes melting the thermoplastic polymer in the mixture to produce a molten mixture in which the glass fibers and cellulose pulp fibers are dispersed, injecting the molten mixture into a mold to form a part, and removing the formed part from the mold after a cycle time that is at least 10% less than the cycle time required for forming the part using a comparable molten mixture that includes the thermoplastic polymer but that excludes the cellulose pulp fibers.

Further details for the various aspects and embodiments summarized above are provided in the sections below.

Thermoplastic Polymer

As noted above, in the composite materials in accordance with the present disclosure, the term “thermoplastic polymer” refers to the thermoplastic polymer or polymers that form a continuous matrix throughout which one or more of the various other components of the composite are dispersed, including the filler material, the cellulose pulp fibers, and the additives. As such, the thermoplastic polymer may be referred to herein as the “matrix polymer” or the “polymeric matrix.”

A wide variety of polymers conventionally recognized in the art as suitable for melt processing are useful as the polymeric matrix. The polymeric matrix substantially includes polymers that are sometimes referred to as being difficult to melt process, especially when combined with an interfering element or another immiscible polymer. They include both hydrocarbon and non-hydrocarbon polymers. Examples of useful polymers include, but are not limited to polypropylene, polyethylene, polylactic acid, polystyrene, polystyrene copolymers, polyoxymethylene (also referred to as “acetals”), cellulose acetate, cellulose proprionate, cellulose butyrate, polycarbonates, polyethylene terephthalate, polyesters other than polyethylene terephthalate, polyacrylates, polymethacrylates, fluoropolymers, polyamides, polyetherimide, polyphenylene sulfide, polysulfones, poly(p-phenylene oxide), polyurethanes, and thermoplastic elastomers, or combinations thereof.

Each of the aforementioned polymer genera should be understood to encompass all of the species included in the genus, and the various species should also be understood to encompass related species, where appropriate. For example, “polyethylene” may refer to high density polyethylene (HDPE), low density polyethylene (LDPE), linear low density polyethylene (LLDPE), and so forth. “Polystyrene” may refer to high-impact polystyrene and/or other polystyrene polymers. “Polypropylene” may refer to homopolymer polypropylene (“hPP”) as well as various copolymer polypropylenes (“cPP”) such as polypropylene polymerized in the presence of other hydrocarbon monomers such as ethylene, etc. The thermoplastic polymers also encompass completely and partially recycled versions of the respective polymers. Indeed, polymeric matrices derived from recycled plastics are also applicable as they are often lower cost. However, because such materials are often derived from materials coming from multiple waste streams, they may have vastly different melt rheologies. In some cases, this may make the material problematic to process. However, the addition of cellulosic feedstock to a recycled polymer matrix has been found in some cases to increase the melt viscosity and reduce overall variability, thus improving processing.

Cellulose Pulp Fibers

As noted above, in the composite materials in accordance with the present disclosure, the term “cellulose pulp fibers” refers to one or more types of cellulose pulp fiber dispersed throughout the thermoplastic matrix.

For example, the cellulose pulp fiber may be a cellulose wood pulp fiber, such as a bleached wood pulp fibers, bleached chemical wood pulp fibers, Northern bleached softwood kraft (NBSK) pulp fibers, Southern bleached softwood kraft (SBSK) pulp fibers, and dissolving wood pulp fibers, eucalyptus pulp fibers, and hardwood pulp fibers other than eucalyptus pulp fibers, and combinations thereof.

A number of tree species can be utilized as the source of the wood pulp fibers. Coniferous and broadleaf species and mixture of these can be used. These are also known as softwoods and hardwoods. Typical softwood species are various spruces (e.g., Sitka Spruce), fir (e.g., Douglas fir), various hemlocks (e.g., Western hemlock), tamarack, larch, various pines (e.g., Southern pine, White pine, and Caribbean pine), cypress and redwood or mixtures of same. Typical hardwood species are ash, aspen, cottonwood, basswood, birch, beech, chestnut, gum, elm, eucalyptus, maple oak, poplar, and sycamore or mixtures thereof.

The use of softwood or hardwood species may depend in part on the fiber length desired. Hardwood or broadleaf species have a fiber length of 1-2 mm. Softwood or coniferous species have a fiber length of 3.5 to 7 mm. Douglas fir, grand fir, western hemlock, western larch, and southern pine have fiber lengths in the 4 to 6 mm range. Pulping and bleaching and dicing may reduce the average length because of fiber breakage.

Cellulose wood pulp fibers differ from wood fibers because the lignin has been removed and some of the hemicellulose has been removed. These materials stay in wood fibers. The amount of material remaining in a wood pulp fiber will depend upon the process of making it.

For example, in a mechanical pulp, the fibers are separated by mechanical means, such as grinding, and the process may include steaming and some pre-chemical treatment with sodium sulfite. The lignin is softened to allow the fibers to part. Much of the lignin and hemicellulose as well as the cellulose remains with the fiber. The yield, the percentage of material remaining after pulping, is high. The fiber can be bleached with peroxide, but this process does not remove much of the material.

In chemical pulping, the lignin is removed during a chemical reaction between the wood chips and the pulping chemical. Hemicellulose may also be removed during the reaction. The amount of material being removed will depend upon the chemicals being used in the pulping process. The kraft or sulfate process removes less material than the sulfite process or the kraft process with a prehydrolysis stage. The yield is higher in the kraft process than in the sulfite process or kraft with prehydrolysis. The latter two processes have a product with a high percentage of cellulose and little hemicellulose or lignin.

Bleaching chemical wood pulp removes more of the lignin and hemicellulose.

In the manufacture of chemical wood pulp, woody material is disintegrated into fibers in a chemical pulping process. The fibers can then optionally be bleached. The fibers are then combined with water in a stock chest to form a slurry. The slurry then passes to a headbox and is then placed on a wire, dewatered, and dried to form a pulp sheet. Additives may be combined with the fibers in the stock chest, the headbox, or both. Materials may also be sprayed on the pulp sheet before, during or after dewatering and drying. The kraft pulping process is typically used in the manufacture of chemical wood pulp.

As noted above, there is a difference between wood fiber and wood pulp fiber. A wood fiber is a group of wood pulp fibers held together by lignin. The lumens of the wood pulp fibers collapse during the drying process. As such, the dried chemical wood pulp fibers are flat. In dimensional terms, this means that the aspect ratio of the cross-section of a cellulose wood pulp fiber, that is, the ratio of the longer dimension to the shorter dimension, is greater than one. In contrast, the lumens of each of the wood fibers in a wood fiber bundle remain open. As a result, the flat chemical wood pulp fibers are more flexible than wood fibers.

Cellulose wood pulp fibers can be in the form of commercial cellulosic wood pulp. Such pulp is typically delivered in roll or baled form. A pulp sheet has two opposed substantially parallel faces and can be from 0.1 mm to 4 mm thick. In the methods discussed herein, the cellulose pulp fibers may be provided in particulate form for blending or mixing, such as disclosed in U.S. Pat. No. 9,328,231 or 9,617,687 (the entire contents of which are incorporated by reference herein), or in other granulated or comminuted form.

The term “dispersed,” when used to describe cellulose pulp fibers in the composite materials disclosed herein, indicates that the fibers are distributed throughout the polymer matrix in substantially individual form. The extent of such dispersion of the cellulose pulp fibers may be quantified, for example by means of the Dispersion Test described in U.S. Pat. No. 9,328,231, which analyzes an X-ray image of a sample injection molded piece produced from a composite material, and calculates the percentage of fibers that are dispersed (that is, substantially individualized) by counting image artifacts corresponding to undispersed fibers (that is, fiber aggregates or fiber bundles). However, when describing or otherwise referring to the distribution of a material other than cellulose pulp fibers in the composite materials disclosed herein, such as various filler materials (including fibrous materials such as glass fibers), the meaning of the term “dispersed” is meant more broadly to indicate that the material in question is distributed throughout the composite (e.g., in aggregates and/or in individualized form).

As noted in, for example, U.S. Pat. No. 9,328,231, there are challenges associated with dispersing cellulose pulp fibers in a polymer matrix—that is, providing the cellulose pulp fibers in substantially individual form. These challenges mainly relate to the nature of the fibers as a result of the production process. Some fibers, such as cellulose wood pulp fibers (e.g. NBSK and other chemical wood pulp fibers), are initially in a dried pulp sheet. As noted above, drying collapses the pulp fibers. Drying also causes the pulp fibers to bond together through hydrogen bonds. The hydrogen bonds must be broken in order to obtain substantially individual fibers. However, certain processing techniques, such as disclosed in U.S. Pat. No. 9,328,231, can be employed to produce composites in which the cellulose wood pulp fibers are substantially singulated and dispersed in substantially individual form throughout a thermoplastic matrix.

Cellulose pulp fibers suitable for use in the composite materials according to the present disclosure may include high-viscosity pulps. Pulp viscosity relates to degree of polymerization (“DP”) of the pulp. High DP tends to correlate with high strength characteristics of the holocellulose, which results in high strength characteristics of the composite materials into which it is incorporated. High DP also tends to correlate with low thermal degradation, and accordingly lower degrees of color development upon processing and lower odor.

Prior investigations into producing composite materials containing cellulosic pulp fibers dispersed in a matrix polymer, e.g. U.S. Pat. No. 6,270,883 (the entire contents of which are incorporated by reference herein), favor the use of pulps having high-alpha content, that is, pulps with high cellulose and comparatively low hemicellulose content. One example is Ultranier-J, a 98% alpha kraft wood pulp available from Rayonier Performance Fibers. Such pulps are also referred to as dissolving-grade pulps. However, many such pulps tend to have lower viscosity and lower DP. Ultranier-J, for example, has been measured to have a viscosity of 7 cP according to a standard 0.5% CED (or “Cuen”) method, and a low DP, as compared with a representative market pulp (CR54, with a viscosity of 22 cP), e.g., in European Patent App. No. EP1144756.

Thus, high-viscosity pulps are not favored materials for use in polymer composites. “Viscosity” in this sense may refer to any of the variety of methods by which pulp viscosity may be measured. In terms of “high-viscosity pulp,” the term “high-viscosity” may encompass viscosity values higher than those associated with dissolving-grade pulps, such as those associated with market-grade pulps. In some embodiments, the term “high-viscosity” may encompass viscosity values higher than those associated with market-grade pulps.

Filler Material

As noted above, in the composite materials in accordance with the present disclosure, the term “filler material” refers to the material or materials, other than cellulose pulp fibers, dispersed throughout the polymer matrix.

Various fillers and fibers other than chemical wood pulp fibers have been added to polymers in order to provide reinforcement, impart desirable physical characteristics, reduce the amount of polymer needed for a given application, and so forth. In this sense, “filler material” refers to substances that remain solid when the composite material—or more specifically, the polymer matrix—is melted. For reinforcement, fillers are often in fibrous or flaked form, although this is not always the case. A traditional filler for reinforcement is glass fibers, a term that encompasses various industrial classifications of such fibers such as “short glass fibers” and “long glass fibers.” Other non-limiting categories of fillers include various minerals, polymers having a melting point higher than that of the matrix polymer, and lignocellulosic materials. This list of categories is non-exhaustive and the categories themselves are not necessarily mutually exclusive; rather, the list of categories serves to describe the broad spectrum of filler materials suitable for use in the composites and methods in accordance with the present disclosure.

For example, non-limiting examples of minerals include wollastonite, basalt, talc, clay, mica, and calcium carbonate. Non-limiting examples of lignocellulosic materials include wood flour, sawdust, wood fiber, ground wood, jute, hemp, kenaf, and rice hulls. “Polymers having a melting point higher than that of the matrix polymer” may include synthetic or natural polymers, generally in fiber form, such as nylon, rayon or other regenerated cellulose fibers, polyvinyl alcohol, aramid fibers, carbon fibers, chitin, keratin, silk, and so forth. This category may also include combinations of the aforementioned, such as bicomponent fibers, one or both components of which may have a melting point higher than that of the matrix polymer. Additionally, it should be understood that this category may include thermoplastic polymer species listed above as suitable matrix polymers, such as if the matrix polymer has a lower melting point relative to the melting point of such thermoplastic polymers.

Additives

The term “additives” refers to one or more substances that may be incorporated into the composite materials of the present disclosure to facilitate mixing or enhance or otherwise affect the properties imparted by one or more of the other components of the composite materials. Non-limiting examples of conventional additives include antioxidants, light stabilizers, fibers, blowing agents, foaming additives, antiblocking agents, heat stabilizers, impact modifiers, biocides, flame retardants, plasticizers, tackifiers, colorants, processing aids, lubricants, compatibilizers, and pigments. In embodiments of methods of using the composite materials of the present disclosure, the additives may be incorporated in the composite materials. In embodiments of methods of producing the composite materials of the present disclosure, the additives may be added in the form of powders, pellets, granules, or in any other suitable form. The amount and type of conventional additives in the composite materials may vary depending upon the matrix polymer, the type and amount of cellulose pulp fibers and/or filler materials, the desired physical properties of the finished composition, and so forth. Those skilled in the art of melt processing are capable of selecting appropriate amounts and types of additives appropriate to a particular matrix polymer in order to achieve desired physical properties of the finished material.

Rule of Mixtures

In materials science, the Rule of Mixtures is a standard method of predicting the properties of mixtures. Simplified, for a given property, the value of the property that will be possessed or exhibited by the total mixture can be predicted from the values for the components of the mixture by weighting with the volume fraction of the component.

Predicted values for a particular property P can be calculated using the Rule of Mixtures for a system of n components, as follows:

P_{T}=v₁P₁v₂P₂+ . . . +VₙPₙ=Σᵢ(vᵢPᵢ)

With vᵢ representing the volume fraction of the component, such that

v₁+v₂+ . . . +vₙ=1

Weight fraction (xᵢ) may be used when all component densities (ρᵢ) are known, such as by the following relationship:

vᵢ=(xᵢ/ρᵢ)/Σᵢ(xᵢ/ρᵢ)

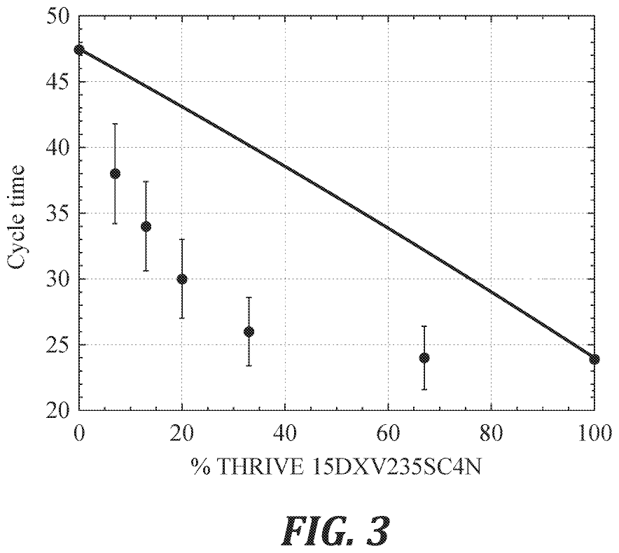

In a binary (e.g., two-component) system, predicted values for a property P can be represented graphically by a line, as discussed in greater detail below with reference to FIGS. 3-18.

Injection Molding

Injection molding is a manufacturing process for producing parts by injecting material into a mold. A common material is a thermoplastic polymer, or combination of thermoplastic polymers. Favorable qualities such as various strength and mechanical properties can be imparted by the use of fillers and other materials that are dispersed throughout the thermoplastic polymer, which forms a surrounding matrix.

Simplified, injection molding uses a ram or screw-type plunger to force molten material into a mold cavity. The material solidifies into a shape that has conformed to the contour of the mold. Typically, the raw material is fed, in pelletized form, through a hopper into a heated barrel having a reciprocating screw. Upon entrance to the barrel, the temperature increases and the Van der Waals forces that resist relative flow of individual chains are weakened as a result of increased space between molecules at higher thermal energy states. This process reduces the viscosity of the material, which enables the polymer to flow with the driving force of the injection unit. The screw delivers the raw material forward, mixes and homogenizes the thermal and viscous distributions of the polymer, and reduces the required heating time by mechanically shearing the material and adding a significant amount of frictional heating to the polymer. When enough material has gathered at the front of the screw, the material is forced, usually at high pressure and velocity, into the part forming cavity in the mold. The packing pressure is applied until the gate (cavity entrance) solidifies. Due to its small size, the gate is normally the first place to solidify through its entire thickness. Once the gate solidifies, no more material can enter the cavity; accordingly, the screw reciprocates and acquires material for the next cycle while the material within the mold cools so that it can be ejected and be dimensionally stable. The cooling step can be reduced by the use of cooling lines circulating water or oil from an external temperature controller. Once the required temperature has been achieved, the mold opens and the part is ejected, typically by one or more pins, sleeves, strippers, etc.

Injection molding can be, and often is, a cyclic operation. Once the part is ejected, the mold closes and the process is repeated. The cooling period usually represents about 40-60% of the cycle time.

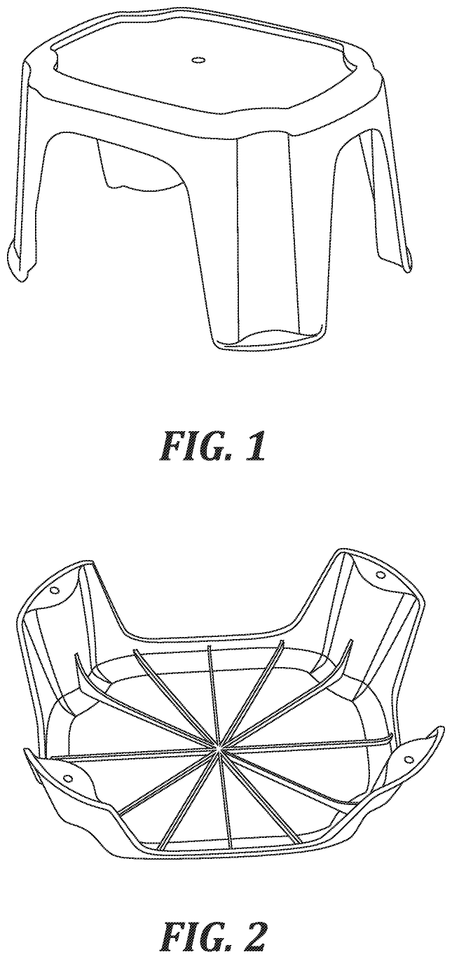

In an example series of studies, a molded part, in the form of a step stool 12″ wide, 9″ deep, and 8″ high, was produced by injection molding using various composite materials. FIGS. 1 and 2 show a representation of the step stool produced in these studies.

Various aspects of the injection molding process using different composite materials, including the cycle time, as well as various tensile and flexural properties exhibited by the formed part, were measured and are discussed below.

Cycle Time Reduction

As noted above, in composite materials in accordance with the present disclosure, the presence of cellulose pulp fibers provides a composite material that achieves significant and unexpected cycle time reduction when used in injection molding, as compared to a comparable composite material that includes the thermoplastic polymer but that excludes the cellulose pulp fibers.

Expressed another way, given a composite material that includes thermoplastic polymer and a filler material, but no cellulose pulp fibers (the so-called “comparable composite material”), replacing at least some of the filler material with cellulose pulp fibers provides a composite material that achieves cycle time reduction in injection molding.

The term “a comparable composite material that includes the thermoplastic polymer but that excludes the cellulose pulp fibers” may encompass one or more composite materials, such as a composite material having, for example, the same weight percent of thermoplastic polymer, but excluding the cellulose pulp fibers.

Specifically, it was found that cycle time reduction of at least 10%, for example 20%, 30%, 40%, 45%, and 50% or more, was achieved with composite materials according to the present disclosure, as compared to cycle times achieved with comparable composite materials that includes the thermoplastic polymer but that excludes the cellulose pulp fibers.

Unless indicated otherwise, all cycle time values disclosed herein are in seconds.

In a first example study, a composite material was produced by dry blending a first composite (polypropylene containing 15 weight % of cellulose pulp fibers) with pure polypropylene (hPP) in the hopper of an injection molding machine. The first composite was in the form of THRIVE 15DXV235SC4N pellets from International Paper. An example of the hPP tested in this study is Total Polypropylene PPH 3825.

FIG. 3 is a graph in which the expected cycle times (in seconds), as predicted by the Rule of Mixtures, are presented in a solid line as the cellulose fiber content increases from 0 weight % (neat hPP) to 15 weight % (corresponding to the cellulose pulp fiber content in THRIVE 15DXV235SC4N).

The Rule of Mixtures line predicts that cycle time will decrease linearly as cellulose pulp fiber content increases. However, actual values of the cycle time for producing the molded stool (depicted as discrete data points, each with error bars representing one standard deviation range in either direction) are substantially below the Rule of Mixtures line, showing an unexpected, sudden, and non-linear decrease in cycle time, even at very low levels of cellulose pulp fiber.

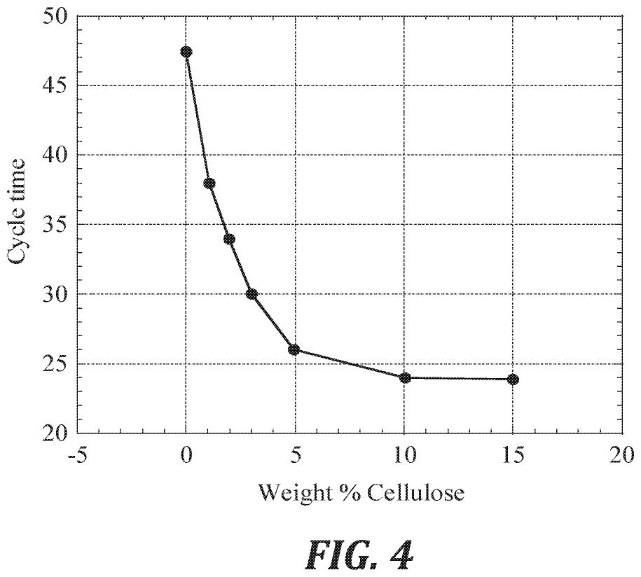

FIG. 4 is another representation of these findings, in the form of a graph showing only the actual cycle time values as they correspond to weight % of cellulose pulp fiber in hPP.

As can be seen, in the first example study, the maximum cycle time reduction, representing a nearly 50% reduction, was achieved at 10 weight % cellulose fiber.

The data shown in FIGS. 3 and 4 are presented below in Table 1.

TABLE 1

| % | weight % | cycle time | % reduction |
|---|---|---|---|
| 15DXV235SC4N | cellulose | (sec) | in cycle time |
| 0 | 0 | 47.44 | — |
| 7 | 1.1 | 38 | 19.9 |
| 13 | 2.0 | 34 | 28.3 |
| 20 | 3.0 | 30 | 36.8 |
| 33 | 5.0 | 26 | 45.2 |
| 67 | 10 | 24 | 49.4 |
| 100 | 15 | 23.9 | — |

Similar effects were observed when cellulose fibers were added to a glass fiber-reinforced thermoplastic composite.

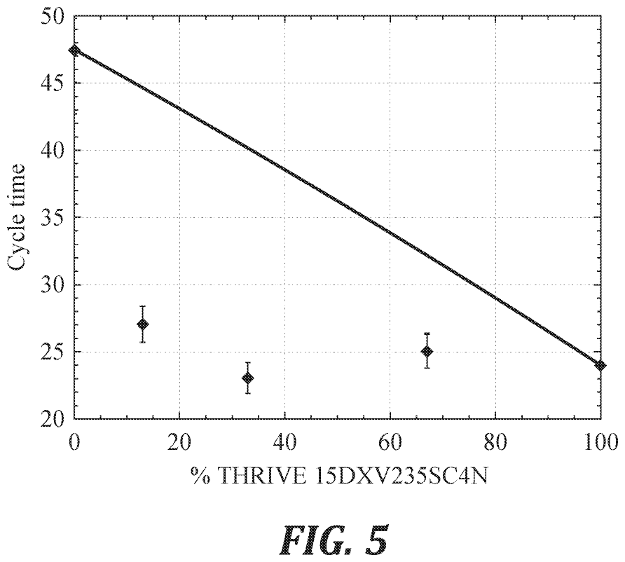

In a second example study, a composite material was produced by dry blending a first composite (polypropylene containing 15 weight % of cellulose pulp fibers, in the form of the aforementioned THRIVE 15DXV235SC4N pellets) with a second composite containing 30% short glass fiber in polypropylene (in the form of PPH2Ff3 pellets from Washington Penn Plastic Co., Inc.). Again, the Rule of Mixtures predicts that cycle time will decrease linearly as cellulose pulp fiber content increases. However, as shown in FIG. 5, which shows actual cycle time values as discrete data points relative to the solid line representing values predicted by the Rule of Mixtures, the cycle time decreased unexpectedly suddenly and non-linearly as the cellulose fiber content increased.

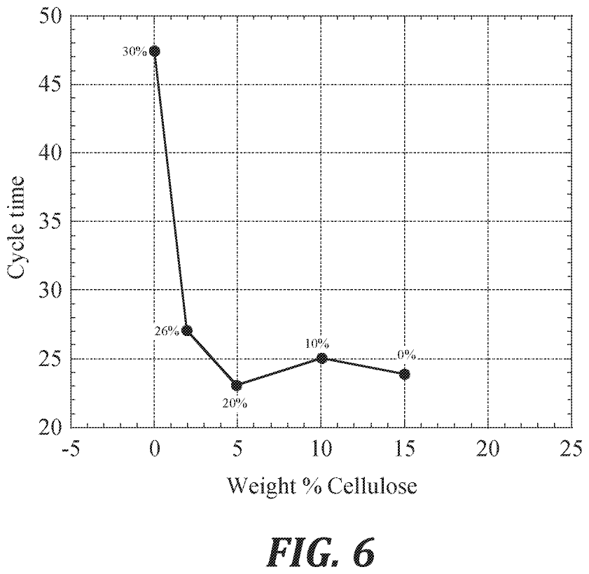

FIG. 6 is another representation of these findings, in the form of a graph showing only the actual cycle time values as they correspond to weight % of cellulose pulp fiber in the composite material. In FIG. 6, the numbers by the data points represent the glass fiber content of the composite material.

As can be seen, in the second example study, the maximum cycle time reduction, of 51.4%, was achieved at 5 weight % cellulose fiber (and 20 weight % short glass fiber).

The data shown in FIGS. 5 and 6 are presented below in Table 2.

TABLE 2

| | | | weight % | | |
|---|---|---|---|---|---|
| | | | short | cycle | % reduction |
| % | weight % | % | glass | time | in cycle |
| 15DXV235SC4N | cellulose | 30SGPP | fiber | (sec) | time |
| 0 | 0 | 100 | 30 | 47.44 | — |
| 13 | 2.0 | 87 | 26 | 27.05 | 43.0 |
| 33 | 5.0 | 67 | 20 | 23.05 | 51.4 |
| 67 | 10 | 33 | 10 | 25.05 | 47.2 |
| 100 | 15 | 0 | 0 | 23.9 | — |

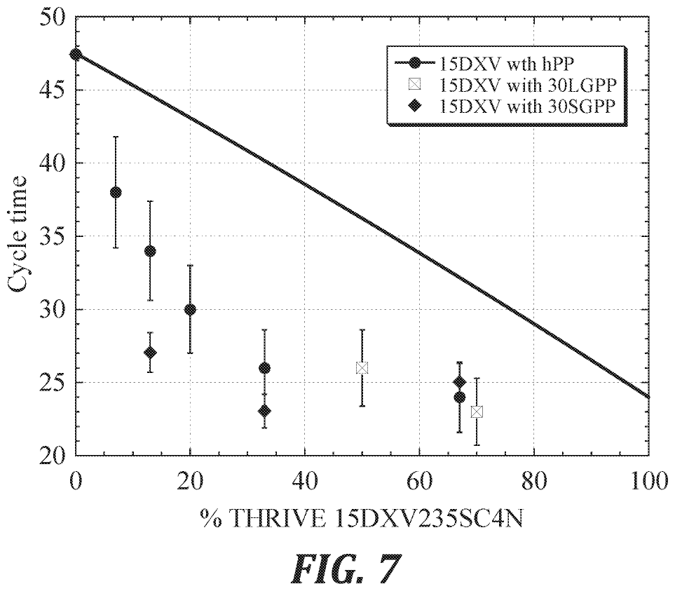

Similar deviations from Rule of Mixtures predicted cycle times were observed when adding cellulose to other glass fiber reinforced polypropylene. FIG. 7 shows the results from the aforementioned first and second example studies, as well as an example study performed with a composite containing 30% long glass fiber in polypropylene (an example form of this composite is Celstran® PP-GF30-05 available from Celanese Corporation).

Similar cycle time deviation was observed with composites including filler materials other than glass fibers, when cellulose pulp fiber composite material was dry blended with other neat or reinforced thermoplastic pellets prior to injection molding an article. These articles had good surface finish and comparable strength.

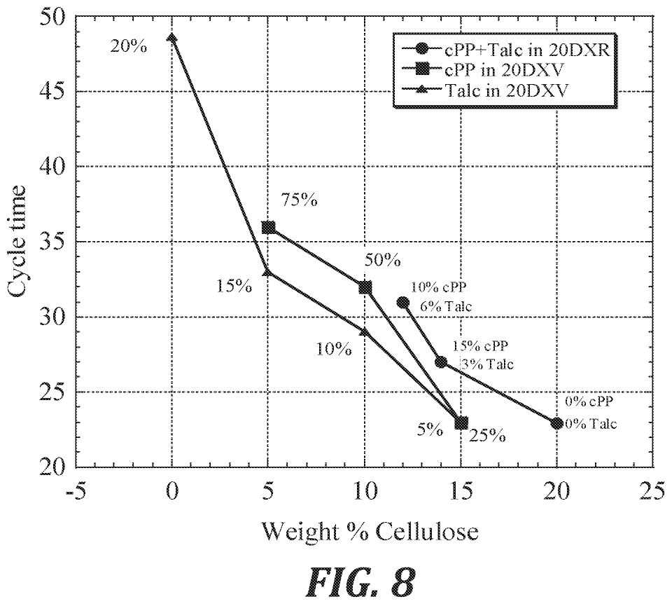

For example, in other example studies, cellulose pulp fiber composite material (specifically, polypropylene containing 20 weight % of cellulose pulp fibers) was dry blended with co-polymer polypropylene (cPP), talc, and a composite of cPP and talc. Cycle time reductions of nearly 50% were achieved in some of these studies, as shown in FIG. 8. The numbers by the data points in FIG. 8 represent the content of cPP, talc, and cPP and talc, as shown in the legend. Note that “XR” cellulose pulp fiber composites (such as “20DXR”) use recycled polypropylene as the matrix polymer, whereas “XV” composites (such as “20DXV”) use non-recycled, or virgin, polypropylene. An example recycled polypropylene used in these composites is available from Ultra Poly Corp. as UP4089HOPPBLK. An example virgin polypropylene used in these composites is the aforementioned Total Polypropylene PPH 3825.

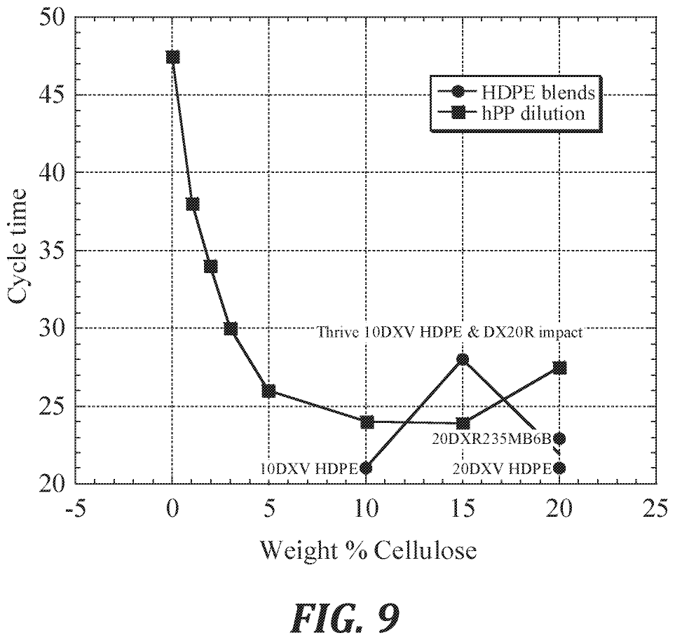

Cycle time deviation was also observed with composites having a matrix polymer other than polypropylene. For example, comparable cycle time reductions were seen using high-density polyethylene (HDPE), as shown in FIG. 9.

In the example studies represented in FIG. 9, 10DXV HDPE and 20DXV HDPE refer, respectively, to composites of high-density polyethylene containing 10 and 20 weight % cellulose pulp fibers.

Based on the example studies discussed and shown herein, and the nature of the departures from the Rule of Mixtures predictions of cycle times, similarly substantial cycle time deviations are predicted for a variety of matrix polymers and broad range of filler materials.

Other Rule of Mixtures Correlations and Deviations

Various composite materials, generally produced via dry blending a cellulose pulp fiber composite material with either a neat matrix polymer, or another composite material containing filler material dispersed throughout a matrix polymer, were tested for a number of properties, such as mechanical and impact properties, and the observed values were compared to Rule of Mixtures predicted values.

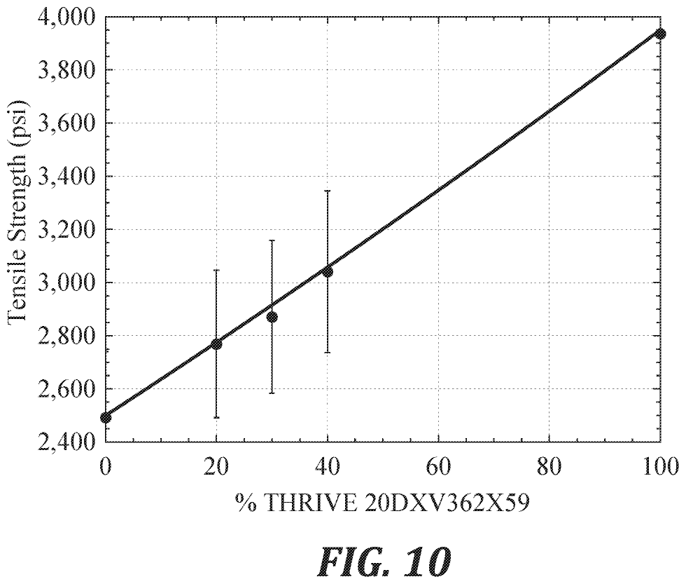

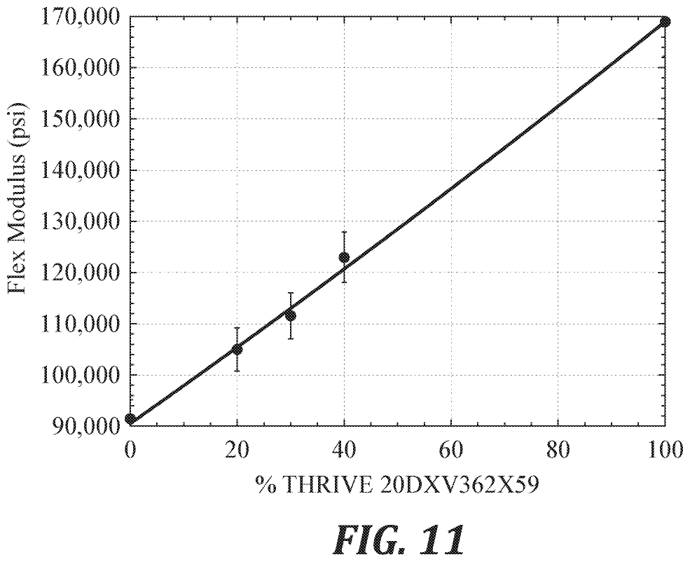

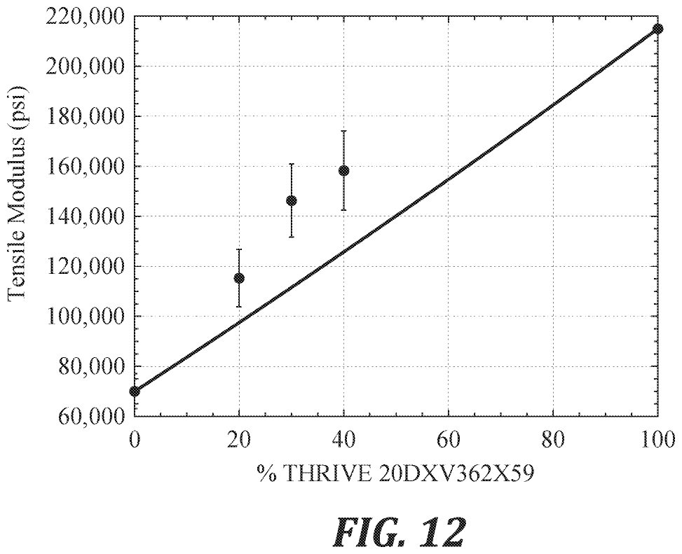

In some studies, the actual values correlated with Rule of Mixtures predicted values. For example, FIGS. 10-12 show that mixtures of a composite of high-density polyethylene containing 20 weight % cellulose pulp fibers was mixed with pure HDPE (in the form of Marlex 9005, from Chevron Phillips Chemical Co.) generally correlate with Rule of Mixtures predicted values in, respectively, tensile strength as shown in FIG. 10 (tested according to ASTM D638), flexural modulus as shown in FIG. 11 (tested according to ASTM D790 Proc A), and tensile modulus as shown in FIG. 12 (tested according to ASTM D638).

In other studies, actual values deviate from Rule of Mixtures predicted values.

Izod impact testing is a standard method of determining the impact resistance of materials. In the test according to ASTM D256, a pivoting arm is raised to a specific height and released, swinging down to strike a notched sample of the material. The height of the arm after striking the sample is used to determine Izod impact energy

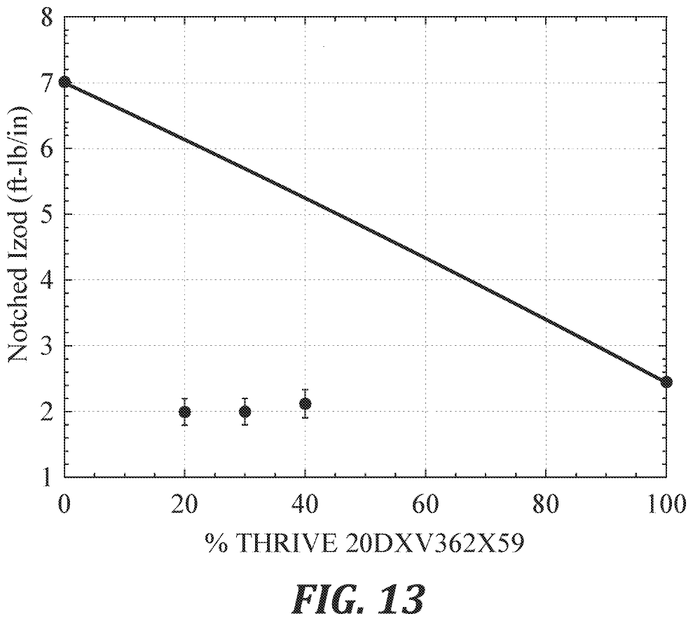

FIG. 13 shows the result of example studies of Izod testing of various composite materials, as compared with Rule of Mixtures predictions of Izod impact energy. In these studies, a composite of high-density polyethylene containing 20 weight % cellulose pulp fibers was mixed with pure HDPE (Marlex 9005). As shown in FIG. 13, adding even a small amount of fiber (20% of the HDPE-cellulose composite equates to 4 weight % cellulose pulp fiber) results in a substantial deviation from the solid line of predicted values.

Elongation at break, also known as fracture strain, is the ratio between changed length and initial length after breakage of the test specimen. It expresses the capability of a material to resist changes of shape without crack formation. The elongation at break may be determined by tensile testing in accordance with EN ISO 527.

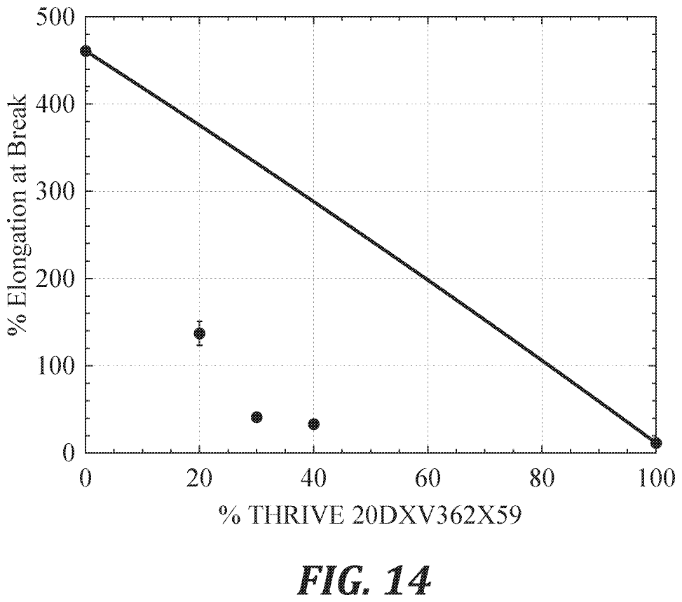

Tensile elongation at break can also be tested in accordance with ASTM D638. FIG. 14 shows the result of example studies of elongation testing according to the standard, of various composite materials, as compared with Rule of Mixtures predictions of values. The materials used are the same as those tested in the Izod impact studies.

As noted above, FIGS. 10-14 show test results for example blends of a neat polymer with composite that includes thermoplastic polymer and cellulose pulp fibers.

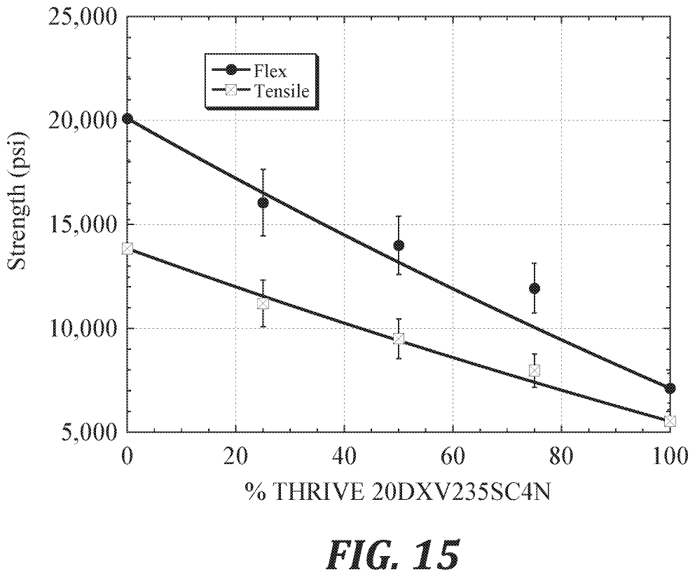

FIGS. 15-18 show test results for example blends of a first composite that includes thermoplastic polymer and glass fibers with a second composite that includes thermoplastic polymer and cellulose pulp fibers.

In an example study, a composite material was produced by dry blending a first composite (polypropylene containing 20 weight % of cellulose pulp fibers, in the form of THRIVE 20DXV235SC4N pellets from International Paper) with a second composite containing 30% long glass fiber in polypropylene (such as Celstran® PP-GF30-05). The Rule of Mixtures predicts that values for both flexural strength and tensile strength (tested according to ASTM D790 Proc A and ASTM D638, respectively) will decrease linearly as cellulose pulp fiber content increases. As shown in FIG. 15, there is good agreement between actual values for these properties relative to the solid lines representing predicted values by the Rule of Mixtures.

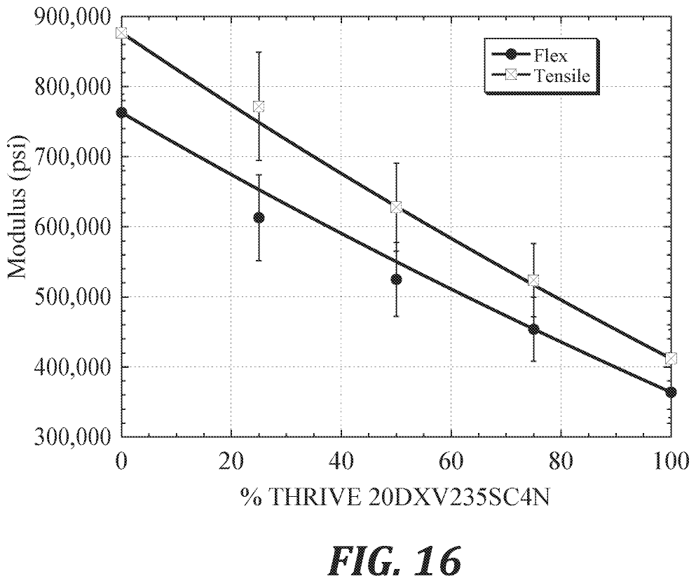

For blends of the aforementioned composites, the Rule of Mixtures predicts that values for both flexural modulus and tensile modulus (tested according to ASTM D790 Proc A and ASTM D638, respectively) will also decrease linearly as cellulose pulp fiber content increases. FIG. 16 shows that there is similarly good agreement between actual values for these properties relative to the solid lines representing predicted values by the Rule of Mixtures.

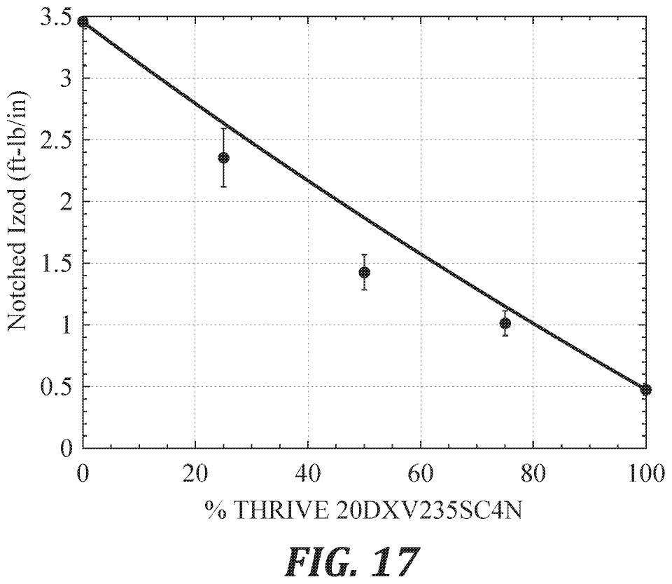

Similarly, for the aforementioned blends, there is good correlation between Rule of Mixtures predicted values for Izod impact energy, which is expected to decrease linearly as cellulose pulp fiber content increases, with actual values, as shown in FIG. 17.

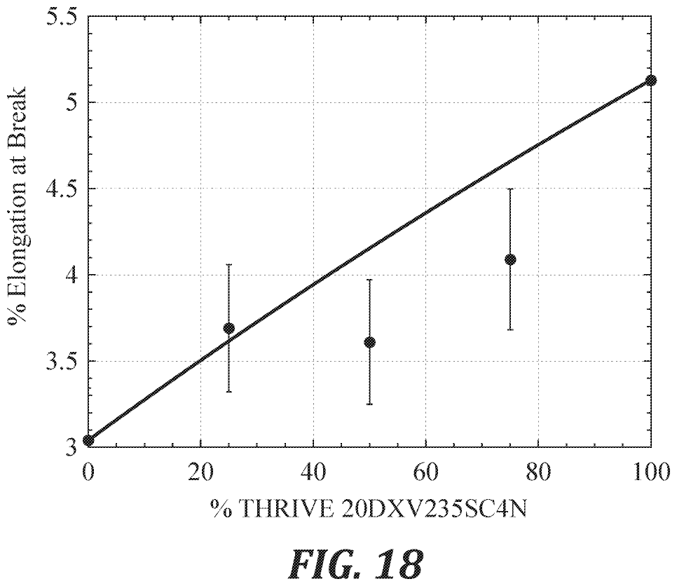

Tensile elongation at break for the aforementioned blends is expected to increase linearly as cellulose pulp fiber content increases. FIG. 18 shows that there is much better agreement between actual values and predicted values as compared to blends that do not include glass fibers (as shown, for example, in FIG. 14).

Although there are exceptions, some general trends from the example studies summarized herein include the following:
In strength and stiffness properties (tensile strength, flexural strength, tensile modulus, flexural modulus) composite materials that do not include a filler material such as glass fibers tend to agree with Rule of Mixtures predictions of value changes as cellulose pulp fiber content increases.
In impact related properties, or properties that represent catastrophic failure such as tensile elongation at break, composite materials that do not include a filler material such as glass fibers tend to deviate from Rule of Mixtures predictions of value changes as cellulose pulp fiber content increases.
In impact related properties, composite materials that include a filler material such as glass fibers tend to agree with Rule of Mixtures predictions of value changes as cellulose pulp fiber content increases.
In some properties, such as cycle time, composite materials that include a filler material such as glass fibers tend to strongly deviate from Rule of Mixtures predictions of value changes as cellulose pulp fiber content increases.

These aforementioned “general trends” are intended to summarize observed effects and are not meant as predictions. However, some other effects that may be predicted from the use of cellulose pulp fibers in the composite materials according to the present disclosure are discussed below.

Injection Molding Temperature Reduction

It has been found that composites of cellulose pulp fiber in thermoplastic polymer tend to self-heat when sheared, such as during melt-mixing, to a greater extent than pure thermoplastic polymer or glass fiber-reinforced thermoplastic polymer. Accordingly, it is expected that composite materials that include cellulose fibers can maintain temperature in a molten state to a greater extent as compared to a comparable molten mixture that includes the thermoplastic polymer but that excludes the cellulose pulp fibers. Under some conditions, longer parts may be molded easier than with such comparable composites. Accordingly, it may not be necessary to externally heat some molds when using the composite materials of the present disclosure, to the extent that may be required with comparable composites. Additionally, the increased tendency to self-heat, owing to the presence of cellulose pulp fibers in the composite materials of the present disclosure, is expected to allow a lower injection molding temperature to be used as compared to a comparable molten mixture that includes the thermoplastic polymer but that excludes the cellulose pulp fibers.

For example, standard practice using glass-reinforced polypropylene composites is to use an injection molding temperature of about 450° F. In contrast, cellulose-reinforced polypropylene composites use an injection molding temperature of about 375° F. Accordingly, it is expected that the use of cellulose pulp fibers with glass-reinforced polypropylene composites will allow a lower injection molding temperature to be used as compared to standard injection molding temperatures for glass-reinforced polypropylene composites.

Reduced Anisotropy

Glass fibers typically have a circular cross-section, with an aspect ratio (that is, the ratio of the longer dimension to the shorter dimension) equal or about equal to 1. As noted above, cellulose pulp fibers, owing to the collapsed or flattened character imparted as a result of processing, usually possess a cross-section that has an aspect ratio greater than 1. For example, the thickness of a cellulose pulp fiber is in the range of about 5 microns, whereas the width is in the range of about 20 microns. As such, an example aspect ratio of the cross-section of a cellulose wood pulp fiber is about 4.

In injection molding, fibrous material in the molten material, such as glass fibers and cellulose fibers, will typically align itself with the length of the fiber oriented in the direction of the flow of the molten material. In general, this means that various characteristics of a molded part that are imparted by the presence of the fibrous material, such as some flexural and tensile properties (e.g. tensile strength, tensile stiffness), may be greatest when measured in the direction of the fiber orientation. Such properties are anisotropic due to the length of the fibers in comparison to the thickness, i.e., the property may be greatest in the direction of the length of the fiber (or “flow direction”) and dramatically reduced in directions transverse to this (“cross-flow directions”). However, due to the higher aspect ratio of cellulose pulp fibers relative to fibers characterized by a roughly circular cross section, some of the aforementioned tensile and flexural properties may be increased in cross-flow directions. Accordingly, anisotropy of such properties in a molded part may be decreased by the presence of cellulose pulp fibers in the composite material used to produce the part.

Anisotropy may be quantified as the ratio of the property in a cross-flow direction divided by the property in the flow direction. In a perfectly isotropic system, the ratio is 1. An example composite of 20 weight % long glass fibers in polypropylene exhibits anisotropy in tensile strength of 0.70, whereas in 20 weight % short glass fibers in polypropylene it is 0.77. In contrast, an example composite of 20 weight % cellulose pulp fibers in polypropylene exhibits anisotropy in tensile strength of 0.92. Accordingly, it is thought that the use of cellulose pulp fibers with glass-reinforced polypropylene composites will reduce anisotropy.

Part Shrinkage

In addition to cycle time, several process variables or parameters associated with the injection molding process, as carried out in producing the stepstool shown in FIG. 1, were observed in order to ascertain various effects of cellulose pulp fibers in the composite materials. These include injection time, peak pressure, pack time, pack pressure, part weight, Modified Gardner (J), Gardner Impact Mean Failure Energy (J), average height, height shrink rate, height shrinkage, major axis rulered, major axis shrink rate (in/in), major axis shrinkage (%), minor axis (in), minor axis shrink rate (in/in), minor axis shrinkage (%), max load (lbf), ext A max load (in), max slope (lb/in), and failure mode, among others.

The results tended to show, among other effects, that the addition of cellulose pulp fibers to composite materials unexpectedly resulted in less shrinkage of the molded part. In this context, shrinkage (as a general concept, and specifically as quantified by some of the parameters listed above) is the contraction of a molded part as it cools after injection. Most part shrinkage occurs in the mold while cooling, but a small amount of shrinkage may occur after ejection, as the part continues to cool.

Injection molded part shrinkage units can be expressed as thousandths of an inch per linear inch (0.00X/in/in). Shrink rates for many polymers tend vary between about 0.001/in/in and about 0.020/in/in, with a common value being around 0.006/in/in. Shrinkage is considered when designing and tooling a mold, to ensure that the finished part, after shrinkage, possesses the desired dimensions. For example, when calculating shrinkage, the tooling engineer may simply scale the part by 1.00X. However, part dimensions and physical characteristics (e.g., inclusion of holes or other apertures, dimensional variability, reduced thickness of one or more portions), or other demands of the molding process (e.g., close tolerances, flow fronts meeting at different angles, and or running different directions at different places in the part) may require a more complex calculation to accommodate shrinkage.

As a further complicating factor, some materials exhibit asymmetrical shrinkage. Glass fiber reinforced polymers, especially those that include long glass fibers, may shrink less in the flow direction and more in a cross-flow direction, due to the aforementioned tendency of fibers to align themselves with the flow of the molten material.

Thus, a composite material that exhibits less shrinkage may be advantageous in that designing and tooling a mold for use with such a material may be more efficient, requiring less calculation in the design and/or less adjustment by a tooling engineer. Molds for use with such composite materials may be more easily designed to accommodate or incorporate close tolerances, and so forth.

Moreover, owing to the higher cross-sectional aspect ratio of cellulose pulp fibers relative to fibers characterized by a roughly circular cross section, it is thought that the asymmetrical shrinkage exhibited by glass fiber reinforced polymers may be reduced as a result of incorporating cellulose pulp fibers into such composite materials. For example, using the composite materials in accordance with the present disclosure (or, more particularly, molten mixtures produced therefrom) may allow using and/or producing a mold having one or more dimensional characteristics that are closer to the desired final dimensional characteristics of the molded part than may be suitable using a comparable composite material or molten mixture that includes the thermoplastic polymer but that excludes the cellulose pulp fibers.

### Example Embodiments of Composite Materials

Given the above, a first example embodiment of a composite material in accordance with the present disclosure includes a thermoplastic polymer, cellulose pulp fibers, and a filler material, wherein the thermoplastic polymer is a matrix throughout which the cellulose pulp fibers and filler material are dispersed. Put another way, such composite materials include a thermoplastic polymer having cellulose pulp fibers and filler material dispersed throughout.

The thermoplastic polymer in such a composite material includes one or more polymers selected from the group consisting of polypropylene, polyethylene, polylactic acid, polystyrene, polystyrene copolymers, polyoxymethylene, cellulose acetate, cellulose proprionate, cellulose butyrate, polycarbonates, polyethylene terephthalate, polyesters other than polyethylene terephthalate, polyacrylates, polymethacrylates, fluoropolymers, polyamides, polyetherimide, polyphenylene sulfide, polysulfones, poly(p-phenylene oxide), polyurethanes, and thermoplastic elastomers.

The filler material in such a composite material includes one or more materials selected from the group consisting of glass fibers, minerals, polymers having a melting point higher than that of said thermoplastic polymer, and lignocellulosic materials.

For example, the filler material may be glass fibers. Optionally, the filler material includes one or more minerals selected from the group consisting of wollastonite, basalt, talc, clay, mica, and calcium carbonate. The filler material may include one or more lignocellulosic materials selected from the group consisting of wood flour, sawdust, wood fiber, ground wood, jute, hemp, kenaf, and rice hulls. The filler material may include one or more polymers selected from the group consisting of nylon, rayon or other regenerated cellulose fibers, polyvinyl alcohol, aramid fibers, carbon fibers, chitin, keratin, and silk.

The cellulose pulp fibers in such a composite material may include cellulose wood pulp fibers selected from the group consisting of chemical wood pulp fibers, bleached wood pulp fibers, bleached chemical wood pulp fibers, Northern bleached softwood kraft (NBSK) pulp fibers, Southern bleached softwood kraft (SBSK) pulp fibers, and dissolving wood pulp fibers, eucalyptus pulp fibers, and hardwood pulp fibers other than eucalyptus pulp fibers. The cellulose wood pulp fibers may have a viscosity higher than that associated with dissolving-grade pulps. The cellulose wood pulp fibers may have a viscosity higher than that associated with market-grade pulps.

Such a composite material may include one or more additives selected from the group consisting of compatibilizers, lubricants, coupling agents, impact modifiers and acid scavengers.

The composition of the composite material may be as desired. For example, in some embodiments, the composite material includes at least 60 weight % of the thermoplastic polymer and at least 2 weight % cellulose pulp fibers. For example, in some embodiments, the composite material includes at least 5, 10, or 15 weight % cellulose pulp fibers. In some embodiments, the composite material includes at least 5 weight % glass fibers, for example at least 10 weight % glass fibers. In some embodiments, the composite material includes no more than 20 weight % additives, for example no more than 10, 5, or 2 weight % additives.

In some embodiments, an injection molded part produced from the molten composite material exhibits a cycle time reduction of at least 10% compared to the cycle time required for producing the part using a comparable molten composite material that includes the thermoplastic polymer but that excludes the cellulose pulp fibers. For example, the cycle time reduction may be at least 20%, 30%, 40%, 45%, or 50%, compared to the cycle time required using the comparable molten composite material.

In some embodiments, an injection molded part produced from the molten composite material exhibits less shrinkage upon cooling as compared to the same part produced from a comparable molten composite material that includes the thermoplastic polymer but that excludes the cellulose pulp fibers.

In some embodiments in which the filler material in the composite material is or includes glass fibers, an injection molded part produced from the molten composite material is less anisotropic in one or more mechanical properties compared to the same part produced from a comparable composite material that includes the thermoplastic polymer but that excludes the cellulose pulp fibers, and/or less asymmetrical in shrinkage upon cooling compared to the same part produced from a comparable composite material that includes the thermoplastic polymer but that excludes the cellulose pulp fibers.

In some embodiments, the composite material is in solid form, for example in pellet form. In some embodiments, a molten material is produced by melting thermoplastic polymer of the composite material.

In an example embodiment of a composite material, such as corresponding to those tested in the example studies discussed above, the thermoplastic polymer makes up at least 60 weight % of the composite material, the cellulose pulp fibers make up at least 2 weight % of the composite material, the filler material includes glass fibers, which make up at least 2 weight % of the composite material, and the additives make up no more than 20 weight % of the composite material.

In a specific example embodiment, such as corresponding to the composite materials tested in the second example study discussed above and shown in FIG. 3, a composite material according to the present disclosure includes at least 60 weight % polypropylene, at least 5 weight % cellulose wood pulp fibers, at least 10 weight % glass fibers, and no more than 10 weight % additives selected from the group consisting of compatibilizers, lubricants, coupling agents, impact modifiers and acid scavengers.

In another specific example embodiment, such as corresponding to the composite materials tested in the other sample studies discussed above and shown in FIG. 4, a composite material according to the present disclosure includes at least 60 weight % polypropylene, at least 5 weight % cellulose wood pulp fibers, at least 5 weight % talc, and no more than 10 weight % additives selected from the group consisting of compatibilizers, lubricants, coupling agents, impact modifiers and acid scavengers.

Example Embodiments of Part Production Methods

There are various methods for molding a part using the composite materials of the present disclosure, in light of the concepts and descriptions above.

A first example embodiment of such a method includes injecting a molten mixture of thermoplastic polymer, filler material, and cellulose pulp fibers into a mold, wherein the thermoplastic polymer forms a matrix throughout which the filler material and cellulose pulp fibers are dispersed, to form a part. Such a method then includes removing the formed part from the mold after a cycle time that is at least 10% less than the cycle time required for forming the part using a comparable molten mixture that includes the thermoplastic polymer but that excludes the cellulose pulp fibers. For example, removing the formed part may be done after a cycle time that is at least 20%, 30%, 40%, 45%, or 50% less than the cycle time required using the comparable molten mixture.

In some embodiments, the method includes, prior to injecting, providing the molten mixture.

The molten mixture, in some embodiments, is provided by combining thermoplastic polymer in solid form, filler material, and cellulose pulp fibers, and melt-mixing the combined components.

As noted above, there are many ways in which this can be accomplished. Some methods include dry blending the components, in individual or already-combined form, with each other. For example, in some methods, combining includes dry blending two composites that both include thermoplastic polymer, and wherein the compositional makeup of the thermoplastic polymer is different in each of the two composites. In some methods, combining includes dry blending a first composite that includes thermoplastic polymer and filler material with a second composite that includes thermoplastic polymer and cellulose pulp fibers. In some methods, combining includes dry blending cellulose pulp fibers with a composite that includes thermoplastic polymer and filler material. In some methods, combining includes dry blending filler material with a composite that includes thermoplastic polymer and cellulose pulp fibers. In some methods, combining includes dry blending filler material and cellulose pulp fibers with thermoplastic polymer. In some methods, combining includes placing thermoplastic polymer, filler material, and cellulose pulp fibers (either individually and/or in already-combined form) into a hopper of an injection molding system. In such methods, the melt-mixing includes melting at least some of the thermoplastic polymer in the barrel of the injection molding system.

In a specific example embodiment, such as corresponding to the composite materials produced and tested in the second example study, a method includes dry blending a first composite of thermoplastic polymer and glass fibers with a second composite of thermoplastic polymer and cellulose fibers to produce a mixture comprising at least 60 weight % thermoplastic polymer and at least 2 weight % cellulose fibers. The method then includes melting the thermoplastic polymer in the mixture to produce a molten mixture in which the glass fibers and cellulose pulp fibers are dispersed, injecting the molten mixture into a mold to form a part, and removing the formed part from the mold after a cycle time that is at least 10% less than the cycle time required for forming the part using a comparable molten mixture that includes the thermoplastic polymer but that excludes the cellulose pulp fibers.

For example, the dry blending can include providing the first and second composites to a hopper of an injection molding system, and the melting can include moving the mixture through the barrel of the injection molding system. The thermoplastic polymer can be polypropylene. The formed part can be removed after a cycle time that is at least, for example, 20%, 30%, 40%, 45%, or 50% less than the cycle time required for forming the part using the comparable molten mixture.

As an alternative to dry blending, the molten mixture, in some embodiments, is provided by placing a solid composite that includes all of the components of the composite material (i.e. thermoplastic polymer, filler material, cellulose pulp fibers, and optionally additives) into an injection molding system, followed by melting at least some of the thermoplastic polymer in the injection molding system. In other words, in such methods, the composite material is pre-blended (and, for example, shaped into pellets) upon introducing it to the injection molding system. Thus, some embodiments include producing the solid composite, i.e. upstream of its introduction into the injection molding system. Production may be accomplished by all manner of methods. For example, in some methods, producing includes melt-processing two composites that both include thermoplastic polymer, and wherein the compositional makeup of the thermoplastic polymer is different in each of the two composites. In some methods, producing includes melt-processing a first composite that includes thermoplastic polymer and filler material with a second composite that includes thermoplastic polymer and cellulose pulp fibers. In some methods, producing includes melt-processing cellulose pulp fibers with a composite that includes thermoplastic polymer and filler material. In some methods, producing includes melt-processing filler material with a composite that includes thermoplastic polymer and cellulose pulp fibers. In some methods, producing includes melt-processing filler material and cellulose pulp fibers with the thermoplastic polymer. In such methods, the melt-processing is done using one or more of a single-screw extruder, a twin-screw extruder, and a high-intensity mixer.

One factor that may be considered in opting between a method that includes dry-blending components at the injection molding system (such as dry-blending a composite that includes cellulose pulp fibers with a composite that includes glass fibers) as opposed to a method that includes melt-processing the components upstream of the injection molding system, is the nature of the filler material. Some mechanical properties of a molded part may correlate to the average length of the glass fibers and/or proportion of longer glass fibers in the composite material from which the part is produced. In other words, the proportion of longer glass fibers that remain after processing may have a strong influence on mechanical properties such as impact strength, and so forth. Some glass fiber-reinforced composites are produced by pultrusion, a method in which continuous glass fibers are saturated with a molten polymer, carefully pulled through a heated die, then cut to a desired size. In pellets produced by this process, the glass fibers may be as long as the pellets. For example, some “long glass fiber” pellets are 6-12 mm in length. Although some breakage is expected to occur in processing, dry-blending “long glass fiber” pellets with cellulose-containing pellets in a hopper of an injection molding system, followed by melt-mixing the dry blend, may result in less glass fiber breakage as compared to melt-processing the same pellets together in, for example, an extruder. Less glass fiber breakage typically results in longer average glass fiber length and/or a larger proportion of remaining longer glass fibers. Thus, methods to produce the composite material that include dry-blending may preserve mechanical properties associated with longer glass fiber length, as opposed to methods that include other mixing techniques.

In some methods, injecting is done at a lower injection molding temperature than the injection molding temperature required for forming the part using the comparable molten mixture.

Some methods include producing, and/or using, a mold having one or more dimensional characteristics that are closer to the desired final dimensional characteristics of the molded part as compared to a mold produced for use with the comparable molten mixture.

In the aforementioned methods, the thermoplastic polymer includes one or more polymers selected from the group consisting of polypropylene, polyethylene, polylactic acid, polystyrene, polystyrene copolymers, polyoxymethylene, cellulose acetate, cellulose proprionate, cellulose butyrate, polycarbonates, polyethylene terephthalate, polyesters other than polyethylene terephthalate, polyacrylates, polymethacrylates, fluoropolymers, polyamides, polyetherimide, polyphenylene sulfide, polysulfones, poly(p-phenylene oxide), polyurethanes, and thermoplastic elastomers. In the aforementioned methods, the filler material includes one or more materials selected from the group consisting of glass fibers, minerals, polymers having a melting point higher than that of said thermoplastic polymer, and lignocellulosic materials. For example, the filler material may be glass fibers. Optionally, the filler material includes one or more minerals selected from the group consisting of wollastonite, basalt, talc, clay, mica, and calcium carbonate. The filler material may include one or more lignocellulosic materials selected from the group consisting of wood flour, sawdust, wood fiber, ground wood, jute, hemp, kenaf, and rice hulls. The filler material may include one or more polymers selected from the group consisting of nylon, rayon or other regenerated cellulose fibers, polyvinyl alcohol, aramid fibers, carbon fibers, chitin, keratin, and silk. In the aforementioned methods, the cellulose wood pulp fibers includes fibers selected from the group consisting of chemical wood pulp fibers, bleached wood pulp fibers, bleached chemical wood pulp fibers, Northern bleached softwood kraft (NBSK) pulp fibers, Southern bleached softwood kraft (SBSK) pulp fibers, and dissolving wood pulp fibers, eucalyptus pulp fibers, and hardwood pulp fibers other than eucalyptus pulp fibers. The levels of the various components may be as discussed above.

A second example embodiment of a method for molding a part using the composite materials of the present disclosure includes injecting a molten mixture of thermoplastic polymer, filler material, and cellulose pulp fibers into a mold configured to form a molded part, wherein the thermoplastic polymer forms a matrix throughout which the filler material and cellulose pulp fibers are dispersed. In such an embodiment, the injecting is done at a lower injection molding temperature than the injection molding temperature required for forming the part using a comparable molten mixture that includes the thermoplastic polymer but that excludes the cellulose pulp fibers.

A third example embodiment of a method for molding a part using the composite materials of the present disclosure includes injecting a molten mixture of thermoplastic polymer, filler material, and cellulose pulp fibers into a mold configured to form a molded part, wherein the thermoplastic polymer forms a matrix throughout which the filler material and cellulose pulp fibers are dispersed. Such an embodiment includes producing and/or using a mold having one or more dimensional characteristics that are closer to the desired final dimensional characteristics of the molded part as compared to a mold for use with the comparable molten mixture.

While illustrative embodiments have been illustrated and described, it will be appreciated that the various elements, components, materials, concepts, steps, processes, features, aspects, characteristics, and other topics discussed in this disclosure may be combined in manners other than as explicitly described in other illustrative example embodiments of composite materials and/or methods of using or producing such composite materials, and that such embodiments are within the scope of the disclosure. Further, various changes can be made therein without departing from the spirit and scope of the disclosure.

The embodiments of the invention in which an exclusive property or privilege is claimed are defined as follows:

1. A composite material comprising:
a thermoplastic polymer;
cellulose pulp fibers; and
a filler material;
wherein the thermoplastic polymer is a matrix throughout which the cellulose pulp fibers and the filler material are dispersed.

2. The composite material of claim 1, wherein the thermoplastic polymer includes one or more polymers selected from the group consisting of polypropylene, polyethylene, polylactic acid, polystyrene, polystyrene copolymers, polyoxymethylene, cellulose acetate, cellulose proprionate, cellulose butyrate, polycarbonates, polyethylene terephthalate, polyesters other than polyethylene terephthalate, polyacrylates, polymethacrylates, fluoropolymers, polyamides, polyetherimide, polyphenylene sulfide, polysulfones, poly(p-phenylene oxide), polyurethanes, and thermoplastic elastomers.

3. The composite material of claim 1 or 2, wherein the filler material includes one or more materials selected from the group consisting of glass fibers, minerals, polymers having a melting point higher than that of said thermoplastic polymer, and lignocellulosic materials.

4. The composite material of any of claims 1 through 3, wherein the filler material includes one or more minerals selected from the group consisting of wollastonite, basalt, talc, clay, mica, and calcium carbonate.

5. The composite material of any of claims 1 through 4, wherein the filler material includes one or more lignocellulosic materials selected from the group consisting of wood flour, sawdust, wood fiber, ground wood, jute, hemp, kenaf, and rice hulls.

6. The composite material of any of claims 1 through 5, wherein the filler material includes one or more polymers selected from the group consisting of nylon, rayon or other regenerated cellulose fibers, polyvinyl alcohol, aramid fibers, carbon fibers, chitin, keratin, and silk.

7. The composite material of any of claims 1 through 6, wherein the filler material is glass fibers.

8. The composite material of any of claims 1 through 7, wherein the cellulose pulp fibers include cellulose wood pulp fibers.

9. The composite material of claim 8, wherein the cellulose wood pulp fibers include fibers selected from the group consisting of chemical wood pulp fibers, bleached wood pulp fibers, bleached chemical wood pulp fibers, Northern bleached softwood kraft (NBSK) pulp fibers, Southern bleached softwood kraft (SBSK) pulp fibers, and dissolving wood pulp fibers, eucalyptus pulp fibers, and hardwood pulp fibers other than eucalyptus pulp fibers.

10. The composite material of claim 8 or 9, wherein the cellulose wood pulp fibers have a viscosity higher than that associated with dissolving-grade pulps.

11. The composite material of claim 10, wherein the cellulose wood pulp fibers have a viscosity higher than that associated with market-grade pulps.

12. The composite material of any of claims 1 through 11, further comprising one or more additives selected from the group consisting of compatibilizers, lubricants, coupling agents, impact modifiers and acid scavengers.

13. The composite material of any of claims 1 through 12, wherein the composite material comprises at least 60 weight % of the thermoplastic polymer and at least 2 weight % cellulose pulp fibers.

14. The composite material of claim 13, wherein the composite material comprises at least 5 weight % cellulose pulp fibers.

15. The composite material of claim 13, wherein the composite material comprises at least 10 weight % cellulose pulp fibers.

16. The composite material of claim 13, wherein the composite material comprises at least 15 weight % cellulose pulp fibers.

17. The composite material of any of claims 1 through 16, wherein the filler material includes glass fibers, and wherein the composite material comprises at least 5 weight % glass fibers.

18. The composite material of any of claims 1 through 16, wherein the filler material includes glass fibers, and wherein the composite material comprises at least 10 weight % glass fibers.

19. The composite material of any of claims 12 through 18, wherein the composite material comprises no more than 20 weight % additives.

20. The composite material of claim 19, wherein the composite material comprises no more than 10 weight % additives.

21. The composite material of claim 19, wherein the composite material comprises no more than 5 weight % additives.

22. The composite material of claim 19, wherein the composite material comprises no more than 2 weight % additives.

23. The composite material of any of claims 1 through 22, wherein an injection molded part produced from the composite material exhibits a cycle time reduction of at least 10% compared to the cycle time required for producing the part using a comparable molten mixture that includes the thermoplastic polymer but that excludes the cellulose pulp fibers.

24. The composite material of claim 23, wherein the cycle time reduction is at least 20% compared to the cycle time required using the comparable molten mixture.

25. The composite material of claim 23, wherein the cycle time reduction is at least 30% compared to the cycle time required using the comparable molten mixture.

26. The composite material of claim 23, wherein the cycle time reduction is at least 40% compared to the cycle time required using the comparable molten mixture.

27. The composite material of claim 23, wherein the cycle time reduction is at least 45% compared to the cycle time required using the comparable molten mixture.

28. The composite material of claim 23, wherein the cycle time reduction is at least 50% compared to the cycle time required using the comparable molten mixture.

29. The composite material of any of claims 1 through 28, wherein an injection molded part produced from the composite material exhibits less shrinkage upon cooling as compared to the same part produced from a comparable molten mixture that includes the thermoplastic polymer but that excludes the cellulose pulp fibers.

30. An injection molded part produced from the composite material of any of claims 1 through 29.

31. The injection molded part of claim 30,
wherein the filler material in the composite material is glass fibers, and
wherein the part is less anisotropic in one or more mechanical properties compared to the same part produced from a comparable composite material that includes the thermoplastic polymer but that excludes the cellulose pulp fibers.

32. The injection molded part of claim 30 or 31,
wherein the filler material in the composite material is glass fibers, and
wherein the part is less asymmetrical in shrinkage upon cooling compared to the same part produced from a comparable composite material that includes the thermoplastic polymer but that excludes the cellulose pulp fibers.

33. The composite material of claim any of claims 1 through 32, wherein the composite material is in solid form.

34. A molten material produced by melting the thermoplastic polymer of the composite material of claim 33.

35. The composite material of claim 33, wherein the composite material is in pellet form.

36. The composite material of claim 1,
wherein the thermoplastic polymer comprises at least 60 weight % of the composite material;
wherein the cellulose pulp fibers comprise at least 2 weight % of the composite material;
wherein the filler material includes glass fibers, and wherein the glass fibers comprise at least 2 weight % of the composite material; and
wherein if the composite material comprises additives, the additives comprise no more than 20 weight % of the composite material.

37. A composite material comprising:
at least 60 weight % polypropylene;
at least 5 weight % cellulose wood pulp fibers;
at least 10 weight % glass fibers; and
no more than 10 weight % additives selected from the group consisting of compatibilizers, lubricants, coupling agents, impact modifiers and acid scavengers;
wherein the thermoplastic polymer forms a matrix throughout which the cellulose wood pulp fibers and glass fibers are dispersed.

38. The composite material of claim 37, wherein at least some of the polypropylene is in molten form.

39. A composite material comprising:
at least 60 weight % polypropylene;
at least 5 weight % cellulose wood pulp fibers;
at least 10 weight % glass fibers; and
no more than 10 weight % additives selected from the group consisting of compatibilizers, lubricants, coupling agents and acid scavengers;
wherein the thermoplastic polymer forms a matrix throughout which the cellulose wood pulp fibers and glass fibers are dispersed.

40. A composite material comprising:
at least 60 weight % polypropylene;
at least 5 weight % cellulose wood pulp fibers;
at least 5 weight % talc; and
no more than 10 weight % additives selected from the group consisting of compatibilizers, lubricants, coupling agents, impact modifiers and acid scavengers;
wherein the thermoplastic polymer forms a matrix throughout which the cellulose wood pulp fibers and talc are dispersed.

41. The composite material of claim 40, wherein at least some of the polypropylene is in molten form.

42. A method for molding a part, the method comprising:
injecting a molten mixture of thermoplastic polymer, filler material, and cellulose pulp fibers into a mold, wherein the thermoplastic polymer forms a matrix throughout which the filler material and cellulose pulp fibers are dispersed, to form a part;
removing the formed part from the mold after a cycle time that is at least 10% less than the cycle time required for forming the part using a comparable molten mixture that includes the thermoplastic polymer but that excludes the cellulose pulp fibers.

43. The method of claim 42, further comprising
prior to the injecting, providing the molten mixture by:
combining thermoplastic polymer in solid form, filler material, and cellulose pulp fibers; and
melt-mixing the combined components.

44. The method of claim 43, wherein the combining further includes dry blending two composites that both include thermoplastic polymer, and wherein the compositional makeup of the thermoplastic polymer is different in each of the two composites.

45. The method of claim 43, wherein the combining further includes dry blending a first composite that includes thermoplastic polymer and filler material with a second composite that includes thermoplastic polymer and cellulose pulp fibers.

46. The method of claim 43, wherein the combining further includes dry blending cellulose pulp fibers with a composite that includes thermoplastic polymer and filler material.

47. The method of claim 43, wherein the combining further includes dry blending filler material with a composite that includes thermoplastic polymer and cellulose pulp fibers.

48. The method of claim 43, wherein the combining further includes dry blending filler material and cellulose pulp fibers with thermoplastic polymer.

49. The method of claim 43, wherein the combining includes placing thermoplastic polymer, filler material, and cellulose pulp fibers into a hopper of an injection molding system.

50. The method of any of claims 43 through 49, wherein the combining includes comminuting one or more of the components into particulate form.

51. The method of any of claims 43 through 50, wherein the melt-mixing includes melting at least some of the thermoplastic polymer in the barrel of the injection molding system.

52. The method of any of claims 43 through 51, wherein the melt-mixing is performed prior to introducing the molten mixture to the injection molding system.

53. The method of claim 42, further comprising
prior to the injecting, providing the molten mixture by:
placing a solid composite that includes thermoplastic polymer, filler material, and cellulose pulp fibers into an injection molding system; and
melting at least some of the thermoplastic polymer in the injection molding system.

54. The method of claim 53, further comprising producing the solid composite.

55. The method of claim 54, wherein the producing further includes melt-processing two composites that both include thermoplastic polymer, and wherein the compositional makeup of the thermoplastic polymer is different in each of the two composites.

56. The method of claim 54, wherein the producing further includes melt-processing a first composite that includes thermoplastic polymer and filler material with a second composite that includes thermoplastic polymer and cellulose pulp fibers.

57. The method of claim 54, wherein the producing further includes melt-processing cellulose pulp fibers with a composite that includes thermoplastic polymer and filler material.

58. The method of claim 54, wherein the producing further includes melt-processing filler material with a composite that includes thermoplastic polymer and cellulose pulp fibers.

59. The method of claim 54, wherein the producing further includes melt-processing filler material and cellulose pulp fibers with the thermoplastic polymer.

60. The method of any of claims 55 through 59, wherein the melt-processing is done using one or more of a single-screw extruder, a twin-screw extruder, and a high-intensity mixer.

61. The method of any of claims 42 through 60, wherein the thermoplastic polymer includes one or more polymers selected from the group consisting of polypropylene, polyethylene, polylactic acid, polystyrene, polystyrene copolymers, polyoxymethylene, cellulose acetate, cellulose proprionate, cellulose butyrate, polycarbonates, polyethylene terephthalate, polyesters other than polyethylene terephthalate, poly acrylates, polymethacrylates, fluoropolymers, polyamides, polyetherimide, polyphenylene sulfide, polysulfones, poly(p-phenylene oxide), polyurethanes, and thermoplastic elastomers.

62. The method of any of claims 42 through 61, wherein the filler material includes one or more materials selected from the group consisting of glass fibers, minerals, polymers having a melting point higher than that of said thermoplastic polymer, and lignocellulosic materials.

63. The method of claim 62, wherein the filler material includes one or more minerals selected from the group consisting of wollastonite, basalt, talc, clay, mica, and calcium carbonate.

64. The method of claim 62 or 63, wherein the filler material includes one or more lignocellulosic materials selected from the group consisting of wood flour, sawdust, wood fiber, ground wood, jute, hemp, kenaf, and rice hulls.

65. The method of any of claims 62 through 64, wherein the filler material includes one or more polymers selected from the group consisting of nylon, rayon or other regenerated cellulose fibers, polyvinyl alcohol, aramid fibers, carbon fibers, chitin, keratin, and silk.

66. The method of any of claims 62 through 65, wherein the filler material is glass fibers.

67. The method of any of claims 62 through 66, wherein the cellulose pulp fibers include cellulose wood pulp fibers selected from the group consisting of chemical wood pulp fibers, bleached wood pulp fibers, bleached chemical wood pulp fibers, Northern bleached softwood kraft (NBSK) pulp fibers, Southern bleached softwood kraft (SBSK) pulp fibers, and dissolving wood pulp fibers, eucalyptus pulp fibers, and hardwood pulp fibers other than eucalyptus pulp fibers.

68. The method of claim 67, wherein the cellulose wood pulp fibers have a viscosity higher than that associated with dissolving-grade pulps.

69. The method of claim 42, wherein the molten mixture comprises at least 60 weight % thermoplastic polymer and at least 2 weight % cellulose pulp fibers.

70. The method of claim 69, wherein the molten mixture comprises at least 5 weight % cellulose pulp fibers.

71. The method of claim 69, wherein the molten mixture comprises at least 10 weight % cellulose pulp fibers.

72. The method of claim 69, wherein the molten mixture comprises no more than 15 weight % cellulose pulp fibers.

73. The method of any of claims 69 through 72, wherein the filler material includes glass fibers, and wherein the molten mixture comprises at least 5 weight % glass fibers.

74. The method of any of claims 69 through 72, wherein the filler material includes glass fibers, and wherein the molten mixture comprises at least 10 weight % glass fibers.

75. The method of any of claims 42 through 74, wherein the cycle time is at least 20% less than the cycle time required using the comparable molten mixture.

76. The method of claim 75, wherein the cycle time is at least 30% less than the cycle time required using the comparable molten mixture.

77. The method of claim 75, wherein the cycle time is at least 40% less than the cycle time required using the comparable molten mixture.

78. The method of claim 75, wherein the cycle time is at least 45% less than the cycle time required using the comparable molten mixture.

79. The method of claim 75, wherein the cycle time is at least 50% less than the cycle time required using the comparable molten mixture.

80. The method of any of claims 42 through 79, wherein the injecting further includes injecting at a lower injection molding temperature than the injection molding temperature required for forming the part using the comparable molten mixture.

81. The method of any of claims 42 through 80, further including producing the mold to have one or more dimensional characteristics that are closer to the desired final dimensional characteristics of the molded part as compared to a mold produced for use with the comparable molten mixture.

82. The method of any of claims 42 through 81, further including using a mold having one or more dimensional characteristics that are closer to the desired final dimensional characteristics of the molded part as compared to a mold for use with the comparable molten mixture.

83. A part produced according to the method of any of claims 42 through 82.

84. A method for molding a part, the method comprising:
injecting a molten mixture of thermoplastic polymer, filler material, and cellulose pulp fibers into a mold configured to form a molded part;
wherein the thermoplastic polymer forms a matrix throughout which the filler material and cellulose pulp fibers are dispersed; and
wherein the injecting is done at a lower injection molding temperature than the injection molding temperature required for forming the part using a comparable molten mixture that includes the thermoplastic polymer but that excludes the cellulose pulp fibers.

85. A method for molding a part, the method comprising:
injecting a molten mixture of thermoplastic polymer, filler material, and cellulose pulp fibers into a mold configured to form a molded part;
wherein the thermoplastic polymer forms a matrix throughout which the filler material and cellulose pulp fibers are dispersed, to form a part;
wherein the injecting includes using a mold having one or more dimensional characteristics that are closer to the desired final dimensional characteristics of the molded part as compared to a mold for use with a comparable molten mixture that includes the thermoplastic polymer but that excludes the cellulose pulp fibers.

86. A method for molding a part, the method comprising:
dry blending a first composite of thermoplastic polymer and glass fibers with a second composite of thermoplastic polymer and cellulose fibers to produce a mixture comprising at least 60 weight % thermoplastic polymer and at least 2 weight % cellulose fibers;
melting the thermoplastic polymer in the mixture to produce a molten mixture in which the glass fibers and cellulose pulp fibers are dispersed;
injecting the molten mixture into a mold to form a part;
removing the formed part from the mold after a cycle time that is at least 10% less than the cycle time required for forming the part using a comparable molten mixture that includes the thermoplastic polymer but that excludes the cellulose pulp fibers.

87. The method of claim 86,
wherein the dry blending includes providing the first and second composites to a hopper of an injection molding system, and
wherein the melting includes moving the mixture through the barrel of the injection molding system.

88. The method of claim 86,
wherein the mixture comprises at least 5% cellulose fibers, and
wherein the cycle time is at least 40% less than the cycle time required using the comparable molten mixture.

89. The method of claim 86, wherein the thermoplastic polymer includes one or more polymers selected from the group consisting of polypropylene, polyethylene, polylactic acid, polystyrene, polystyrene copolymers, polyoxymethylene, cellulose acetate, cellulose proprionate, cellulose butyrate, polycarbonates, polyethylene terephthalate, polyesters other than polyethylene terephthalate, polyacrylates, polymethacrylates, fluoropolymers, polyamides, polyetherimide, polyphenylene sulfide, polysulfones, poly(p-phenylene oxide), polyurethanes, and thermoplastic elastomers.

90. The method of claim 89, wherein the thermoplastic polymer is polypropylene.

91. The method of claim 86, wherein the mixture comprises at least 26 weight % glass fibers.

92. A method for molding a part, the method comprising:
providing a solid composite that includes thermoplastic polymer, filler material, and cellulose pulp fibers to an injection molding system;
melting at least some of the thermoplastic polymer in the injection molding system to produce a molten mixture;
injecting the molten mixture into a mold to form a part.

93. A method for molding a part, the method comprising:
dry blending a first composite of thermoplastic polymer and glass fibers with a second composite of thermoplastic polymer and cellulose fibers to produce a mixture comprising at least 60 weight % thermoplastic polymer and at least 2 weight % cellulose fibers;
melting at least some of the thermoplastic polymer in the mixture to produce a molten mixture in which the glass fibers and cellulose pulp fibers are dispersed; and
injecting the molten mixture into a mold to form a part.
